(19) United States
(12) Patent Application Publication
(10) Pub. No.: US 2025/0344922 A1
(43) Pub. Date: Nov. 13, 2025

(54) SYSTEMS AND METHODS FOR ROBOTIC CHEVRON PATTERN NAVIGATION

(71) Applicant: The Procter & Gamble Company, Cincinnati, OH (US)

(72) Inventors: Joost DEBONTH, Schaarbeek (BE); Matthew Stephen BAUER, Loveland, OH (US); Eric Gunnar HURD, Cincinnati, OH (US); Su Yon CHANG, Mason, OH (US)

(21) Appl. No.: 19/190,081

(22) Filed: Apr. 25, 2025

Related U.S. Application Data
(60) Provisional application No. 63/643,493, filed on May 7, 2024.

(51) Int. Cl. A47L 9/28

(52) U.S. Cl. CPC A47L 9/2852; A47L 9/2805; A47L 2201/04

(57) ABSTRACT

A robot is described herein for robotic cleaning and navigation strategies. The robot may be sized or dimensioned for maneuvering for cleaning, disinfecting, or otherwise improving a physical environment (e.g., living spaces, office spaces, or the like), especially those having narrow or varied spaces created by obstacles within the physical environment. The cleaning robot as described herein provide solutions for overcoming problems that arise from cleaning target areas or environments that have typically been difficult for conventional robots to navigate and cover sufficiently for cleaning or otherwise coverage purposes. A novel navigation strategy is implemented comprising a chevron pattern comprising a plurality of segments, which provides for improved coverage, and, therefore, cleaning by a robot within a given environment.

### FIELD

The present disclosure generally relates to robots, such as cleaning robot automation, and, and more particularly to, the field of robotics applied to cleaning, disinfecting, or otherwise improving a physical environment (e.g., living spaces, office spaces, or the like), including those having spaces comprising edge portion(s) and interior portion(s), where a chevron navigation strategy, comprising multiple navigation segments, can be implemented to traverse the interior portion(s) of an environment, and further be implemented to transition between edge and fill states to for cleaning the entirety, or most portions, of an environment.

### BACKGROUND

Existing cleaning robots lack the ability to efficiently maneuver and transition between cleaning states (e.g., an edge and fill state) within a given physical environment. Typically, such cleaning robots are designed to have a wide or otherwise large cleaning footprint designed to clean a wide-open area as the robot moves within a given space. Such large design, however, is prohibitive to effective cleaning in complex spaces, leaving such spaces uncleaned or otherwise unaffected by the cleaning robot.

Further, given their large size, conventional cleaning robots lack fine motor control necessary to navigate or move within complex spaces. While these conventional robots can perform algorithms to clean a large space they fail to account for tight spaces and corners that are typically the most difficult to clean. This issue is especially problematic because physical environments can differ widely by having different shapes, sizes, and dimensions, which prohibits large size robots from effective maneuvering, navigating, or otherwise operating to provide a thorough clean.

For the foregoing reasons, there is a need for a robot configured for cleaning, disinfecting, or otherwise improving a physical environment (e.g., living spaces, office spaces, or the like), including those having spaces comprising edge portion(s) and interior portion(s), with a chevron navigation strategy as further described herein.

### SUMMARY

Generally, a cleaning robot is described herein. The cleaning robot may comprise high fidelity sensor(s) (e.g., joystick or other data rich sensors) for accurate control, maneuverability, or otherwise advanced robotic navigation strategies. Further, in various aspects, the cleaning robot may be sized or dimensioned for maneuvering, cleaning, disinfecting, or otherwise improving a physical environment (e.g., living spaces, office spaces, or the like), including covering or cleaning all or most of the floor space of the physical environment by implementing a chevron navigation strategy, which can transition between edge and fill states. The cleaning robots as described herein provide solutions for overcoming problems that arise from cleaning target areas or environments that have typically been hard for conventional robots to clean, fit, and/or maneuver within.

Additionally, the navigation cleaning protocol described herein can address shortcomings that cleaning robots may face which do not incorporate the ability to localize themselves and create map representations of the environment. For cleaning robots without Simultaneous Localization and Mapping, “SLAM” capability, the navigation cleaning protocol described herein results in superior coverage throughout the environment via, for example, the technique of departing from and returning to a fixed location along a boundary. Such configuration of the robot's navigation cleaning protocol allows the robot to traverse the entire perimeter while periodically and momentarily leaving the perimeter to cover open space.

It is also worth noting that the navigation cleaning protocols described herein can be utilized for any type of robot where superior coverage of an environment is desired. For example, robots which comprise vacuum, cleaning pads (wet or dry), robots which have the capacity to apply a cleaning liquid to a floor surface, robots utilized in lawn care, e.g., mowing robots, etc., may benefit from the navigation cleaning protocols described herein.

In some aspects, the techniques described herein relate to a robot configured for cleaning, the robot including: a body including a chassis and an outer perimeter, and the body further including a front portion, an opposing back portion, and a body length disposed between the front portion and the opposing back portion, wherein the body further includes a cleaning element positioned relative to the front portion, wherein the front portion includes a right side, a left side opposing the right side, and a front portion width disposed between the right side and the left side (e.g., a left-to-right dimension); at least one motor configured to move the robot within an environment; at least one sensor; a processor communicatively coupled to the at least one sensor; a computer memory communicatively coupled to the processor; and computing instructions stored on the computer memory and configured, when executed by the processor, to cause the processor to: actuate the at least one motor to drive the robot in a first direction having a forward motion relative to the front portion of the robot, upon detection of a trigger action, actuate the at least one motor to drive the robot within the environment in a chevron pattern (e.g., a V-shaped pattern) relative to a departure area (e.g., a tip of a chevron where the robot departs from a wall) from the first direction, wherein the chevron pattern includes a plurality of segments, and wherein driving the robot in the chevron pattern includes: driving the robot in a first angled segment away from and relative to the departure area, driving the robot in a second angled segment back toward and relative to the departure area, driving the robot in a third angled segment away from and relative to the departure area, driving the robot in a fourth angled segment back toward and relative to the departure area, wherein at least one of the first angled segment or the second angled segment form a segment angle with respect to at least one of the third angled segment or the fourth angled segment. An interface between the first angled segment and the third or fourth angled segment may comprise a large radius or may comprise a small radius, e.g. essentially a V-shaped interface. Similarly, an interface between the first angled segment and the second angled segment can comprise a radius, e.g. a U-shape.

Preferably, a small radius is utilized for the interface between angled segments as use of larger radii can lead to additional uncovered area. The radius of the interface, including that of the present disclosure, can depend on how the turn is executed. For example, where both wheels are rotating in the same direction and propelling the robot in a forward direction, the turn radius can be large. Where only one wheel is propelling the robot in the forward direction and the other is stationary, the turn radius can be smaller than that where both wheels are propelling the robot in the forward direction. Additionally, it is possible to have the robot wheels rotating in the opposite direction which can cause the robot to make an in-place turn. The radius of this turn is smaller than the prior ones described. However, it is worth noting that the utilization of in-place turns can result in at least a portion of the cleaning pad moving in a reverse direction. To the extent that the cleaning pad has accumulated debris on it, the reverse direction may cause the debris to loosen and fall off of the cleaning pad. This can result in debris being left behind which can be frustrating for the consumer.

The radius utilized between angled segments can be described by a turn radius of the robot. The turn radius of the robot is the distance between the geometric center of the robot and a center point of the circle that represents the trajectory of the arc which the robot drives along. The length of the arc can vary. Preferably, robots in accordance with the present disclosure avoid in-place turns. Preferably robots, in accordance with the present disclosure, perform turns for the interface between angled segments via one wheel propelling the robot in a forward direction and the other wheel being stationary. A radius of the interface between angled segments can be about 500 mm or less, more preferably about 400 mm or less, even more preferably about 300 mm or less, even more preferably about 200 mm or less, or most preferably about 100 mm or less. Moreover, as the robots of the present disclosure preferably avoid in-place turns, particularly for the interface between angled segments, the minimum radius of the interface can be about 10 mm, more preferably about 20 mm, even more preferably about 30 mm, or most preferably about 35 mm. It is worth noting that robots of the present disclosure may perform in-place turns as needed to avoid getting stuck or to maneuvered; however, in the implementation of the angled segments, as noted previously, in-place turns are preferably avoided.

In some aspects, the techniques described herein relate to a robot, wherein each of the first angled segment and the second angled segment form respective segment angles with respect to the third angled segment and the fourth angled segment. Similarly, a boundary angle between at least one of the first angled segment, the second angled segment, the third angled segment, or the fourth angled segment and the boundary can be between about 30 degrees and 67.5 degrees.

In some aspects, the techniques described herein relate to a robot, wherein the segment angle includes an angle between 45 degrees and 120 degrees.

In some aspects, the techniques described herein relate to a robot, wherein the segment angle includes an angle of 90 degrees.

In some aspects, the techniques described herein relate to a robot, wherein the trigger action includes one or more of: (a) a predefined distance traveled in the first direction; (b) an elapsed amount of time traveled in the first direction; or (c) after initiating a maneuver (e.g., after turning from one wall to the next).

In some aspects, the techniques described herein relate to a robot, wherein the trigger action is delayed or is not implemented until travel in the first direction is confirmed. This may comprise, for example, waiting or delaying until travel along a straight edge such as wall is confirmed.

In some aspects, the techniques described herein relate to a robot, wherein the trigger action is determined based on a size or dimension of the environment to be cleaned.

In some aspects, the techniques described herein relate to a robot, wherein the processor is configured to actuate the at least one motor to transition the robot from driving along the first angled segment to the second angled segment, or to transition the robot from driving along the third angled segment to the fourth angled segment, when the sensor detects an object in the environment (e.g., the robot's front edge hits the obstacle).

In some aspects, the techniques described herein relate to a robot, wherein the processor is configured to actuate the at least one motor to transition the robot from driving along the first angled segment to the second angled segment, or to transition the robot from driving along the third angled segment to the fourth angled segment, when the processor determines that the robot has traveled a maximum distance away from the departure area.

In some aspects, the techniques described herein relate to a robot, wherein upon transitioning from the first angled segment to the second angled segment or from the third angled segment to the fourth angled segment, the processor is configured to actuate the at least one motor to rotate the robot rightward relative to the forward motion if the sensor detects a force on the left side, or to rotate the robot leftward relative to the forward motion if the sensor detects a force on the right side. For example, in various aspects, the robot can be configured to turn away from an obstacle that the robot has hit on its right or left side, as the case may be.

In some aspects, the techniques described herein relate to a robot, wherein the robot is configured to implement the chevron pattern in a plurality of instances as the robot moves in the environment, and wherein at least 90 percent of a surface area of the environment is cleaned by the cleaning element.

In some aspects, the techniques described herein relate to a robot, wherein the computing instructions are further configured, when executed by the processor, to cause the processor to: actuate the at least one motor to drive the robot in a second direction opposite first direction and having a forward motion relative to the front portion of the robot, and upon detection of the trigger action, actuate the at least one motor to drive the robot within the environment in a second chevron pattern relative to a second departure area relative to the second direction. For example, the robot may move in multiple passes in the environment, e.g., one clockwise and the other counterclockwise, in order to provide a unique coverage and/or cleaning pattern for maximizing cleaning an environment.

In some aspects, the techniques described herein relate to a robot, wherein the robot moving the cleaning element is configured to hold or collect at least 90 percent of a total amount of debris acquired by the cleaning element as the robot moves in the forward direction.

In some aspects, the techniques described herein relate to a robot, wherein the computing instructions are further configured, when executed by the processor, to cause the processor to: actuate the at least one motor to continue to drive the robot in the first direction following competition of implementation of the chevron pattern, and, wherein a second area of the environment cleaned by the cleaning element following competition of implementation of the chevron pattern overlaps at least partially with a first area of the environment cleaned by the cleaning element before implementation of the chevron pattern. For example, by covering a same, overlapping area (e.g., along the edges) more than once, the robot may clean the edges of the environment more than an interior area of the environment when the robot moves in the chevron pattern. Cleaning the edges more than the interior of an environment can be beneficial as dirt, dust and debris tend to collect near the edges of a room.

In some aspects, the techniques described herein relate to a robot, wherein at least one of: (a) the first angled segment does not overlap with the second angled segment; and/or (b) the third angled segment does not overlap with the fourth angled segment. For example, this may further define a non-overlapping pattern or strategy for cleaning along the edges versus the segments of the chevron pattern. Such techniques may be implemented for the interior of an environment in order to speed the cleaning of the environment.

In some aspects, the techniques described herein relate to a robot, wherein at least one of: (a) the first angled segment overlaps the second angled segment by a first overlap value between 0% to 30%, and preferably by 10%; and/or (b) the third angled segment overlaps the fourth angled segment by a second overlap value between 0% to 30%, and preferably by 10%. Such overlapping segments may be configured for the robot to provide a more thorough clean based on the amount of overlap the robot is configured to implement.

In some aspects, the techniques described herein relate to a robot, wherein the sensor is a joystick sensor, a Hall-Effect sensor, motor current, inertial measurement unit (IM U), and/or other sensor(s) as described herein.

In some aspects, the techniques described herein relate to a robot, wherein the chevron pattern includes a first chevron pattern, and wherein the computing instructions are configured, when executed by the processor, to further cause the processor to: actuate the at least one motor to drive the robot within the environment in a second chevron pattern relative to the first chevron pattern, and wherein the second chevron pattern includes an adjacent area (e.g., near a same wall or edge) that has an second departure area adjacent to the departure area of the first chevron pattern, and wherein the robot maneuvers within the adjacent area to form angled segments of the second chevron pattern that the same or substantially the same pattern of at least one of the first angled segment, the second angled segment, the third angled segment, or the fourth angled segment of the first chevron pattern.

In some aspects, the techniques described herein relate to a robot, wherein the chevron pattern includes a first chevron pattern, and wherein the computing instructions are configured, when executed by the processor, to further cause the processor to: actuate the at least one motor to drive the robot within the environment in a second chevron pattern relative to the first chevron pattern, wherein the second chevron pattern includes an opposite area (e.g., near an opposite wall) that is opposite to the departure area of the first chevron pattern, and wherein the robot maneuvers within the opposite area to form angled segments of the second chevron pattern that mirror at least one of the first angled segment, the second angled segment, the third angled segment, or the fourth angled segment of the first chevron pattern.

In some aspects, the techniques described herein relate to a robot, wherein the chevron pattern is implemented by the processor at least as part of a fill pattern designed to move the robot within an interior portion of the environment, and wherein the computing instructions are configured, when executed by the processor, to further cause the processor to: prior to or following implementation of triggering the action to actuate the at least one motor to drive the robot within the environment in the chevron pattern, implement an edge navigation pattern including moving the robot proximate to one or more edges situated within the environment.

The present disclosure relates to improvements to other technologies or technical fields at least because the present disclosure describes or introduces improvements to computing devices in the field of robotics, whereby a cleaning robot, as described herein, may comprise high fidelity sensor control (e.g., via joystick or other data rich sensors) for robotic navigation strategies. For example, the high-fidelity sensor control configures the robot for moving or otherwise navigating the robot within a physical environment in a chevron navigation strategy, comprising multiple navigation segments, that can be implemented to traverse the interior portion(s) of an environment and transition between edge and fill states to for cleaning the entirety, or most portions, of the environment or otherwise area(s) of the environment.

The present disclosure includes applying certain of the aspect elements with, or by use of, a particular machine, e.g., a robot configured for cleaning, disinfecting, or otherwise improving a physical environment (e.g., living spaces, office spaces, or the like).

In addition, the present disclosure includes specific features other than what is well-understood, routine, conventional activity in the field, and that add unconventional steps that confine the claim to a particular useful application, e.g., cleaning robots configured to clean, disinfect, and/or otherwise improve a physical environment (e.g., living spaces, office spaces, or the like), including covering or cleaning all or most of the floor space of the physical environment by implementing a chevron navigation strategy as described herein.

Advantages will become more apparent to those of ordinary skill in the art from the following description of the preferred aspects which have been shown and described by way of illustration. As will be realized, the present aspects may be capable of other and different aspects, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the system and methods disclosed therein. It should be understood that each Figure depicts a particular aspect of the disclosed system and methods, and that each of the Figures is intended to accord with a possible aspect thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present aspects are not limited to the precise arrangements, orientations, and/or instrumentalities shown, wherein:

FIG. 1 illustrates a perspective view of an example robot for cleaning or otherwise interacting with a space or environment in accordance with various aspects disclosed herein.

FIG. 2A illustrates an exploded view of a portion of the example robot of FIG. 1 in accordance with various aspects disclosed herein.

FIG. 2B illustrates a further exploded view of the example robot of FIG. 1 in accordance with various aspects disclosed herein.

FIG. 2C illustrates a top-down cross-sectional view of the example robot of FIG. 1 in accordance with various aspects disclosed herein.

FIG. 3 illustrates a top view of the example robot of FIG. 1 in accordance with various aspects disclosed herein.

FIG. 4 illustrates a bottom view of the example robot of FIG. 1 in accordance with various aspects disclosed herein.

FIG. 5 illustrates a side view of the example robot of FIG. 1 in accordance with various aspects disclosed herein.

FIG. 6 illustrates a rear view of the example robot of FIG. 1 in accordance with various aspects disclosed herein.

FIG. 7 illustrates a front view of the example robot of FIG. 1 in accordance with various aspects disclosed herein.

FIG. 8 illustrates an example environment in which the robot of FIG. 1 can navigate or otherwise move within in accordance with various aspects disclosed herein.

FIG. 9A illustrates an example multi-directional sensor in accordance with various aspects disclosed herein.

FIG. 9B illustrates the example multi-directional sensor of FIG. 9A with an example plurality or set of plurality of radial zones in accordance with various aspects disclosed herein.

FIG. 10A illustrates an example magnetic-based multi-directional sensor configuration in accordance with various aspects disclosed herein.

FIG. 10B illustrates an example Hall-effect-based multi-directional sensor configuration in accordance with various aspects disclosed herein.

FIG. 10C illustrates an example Time-of-Flight (ToF) s-based multi-directional sensor configuration in accordance with various aspects disclosed herein.

FIG. 11 illustrates a coverage diagram showing example navigation or movement of a robot within an environment in accordance with various aspects disclosed herein.

FIG. 12 illustrates a flowchart for a navigation algorithm for a robot maneuvering in one or more chevron patterns accordance with various aspects disclosed herein.

FIG. 13A illustrates example navigation or movement of a robot in an example chevron pattern in accordance with various aspects disclosed herein.

FIG. 13B illustrates further example navigation or movement of the robot of FIG. 13A in an additional example chevron pattern in accordance with various aspects disclosed herein.

FIG. 14 illustrates a coverage diagram illustrating example edge navigation together with chevron pattern navigation of a robot in accordance with various aspects disclosed herein.

FIG. 15 illustrates example debris and sizes thereof in accordance with various aspects disclosed herein.

The Figures depict preferred aspects for purposes of illustration only. Alternative aspects of the systems and methods illustrated herein may be employed without departing from the principles of the invention described herein.

### DETAILED DESCRIPTION OF THE INVENTION

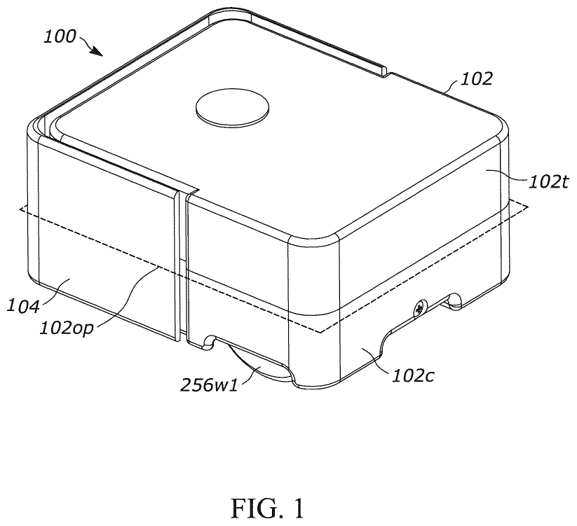

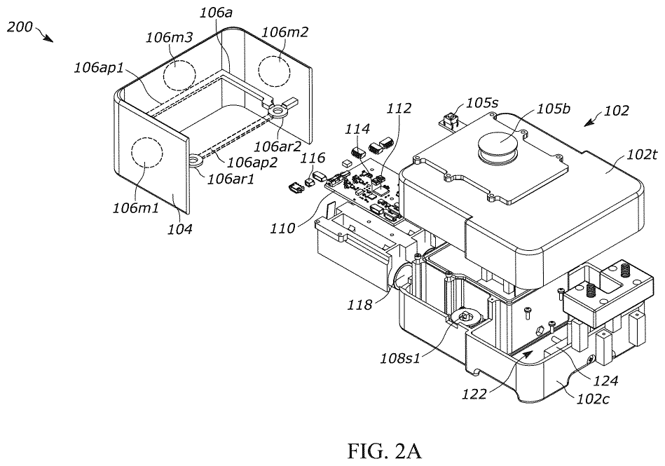

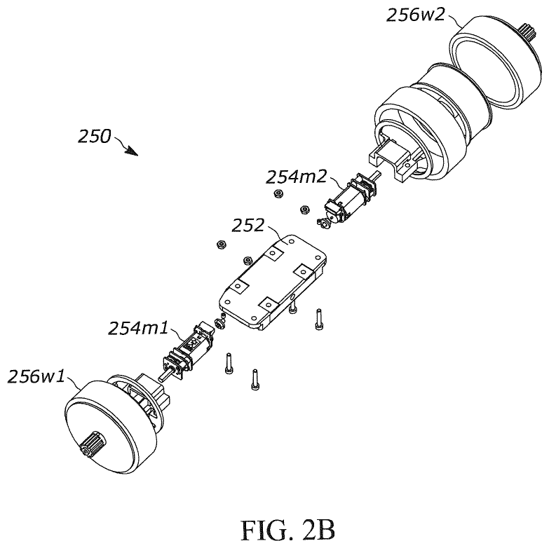

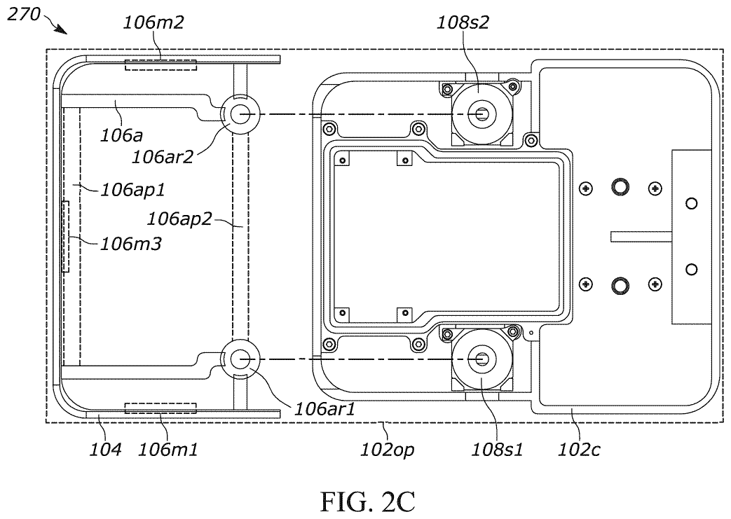

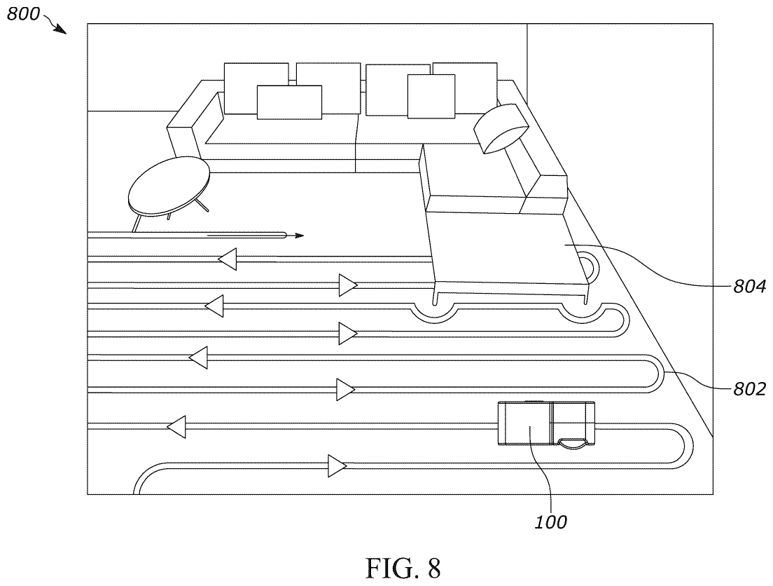

FIG. 1 illustrates a perspective view of an example robot 100 for cleaning or otherwise interacting with a space or environment in accordance with various aspects disclosed herein. As shown in the example of FIG. 1, the robot includes a body 102 comprising a chassis 102c and an outer perimeter 102op. In various aspects, the outer perimeter 102op may comprise or otherwise be formed of various aspects or components of body 102 of robot 100, which may include, by way of non-limiting example, bumper 104, chassis 102c (e.g., the lower portion of body 102), and/or top 102t of body 102. It is to be understood, however, that an outer perimeter (e.g., outer perimeter 102op) can include additional, less, and/or different components of a given robot body (e.g., body 102). More generally, an outer perimeter (e.g., outer perimeter 102op) defines an outermost region of robot 102 which can come into contact (e.g., bump or hit) objects within a cleaning environment (e.g., environment 800 as shown for FIG. 8). Still further, an outer perimeter (e.g., outer perimeter 102) may be formed of a material such as a hard plastic such as polyethylene, or otherwise a material that would otherwise prevent (or mitigate) damage or mark a surface when the outer perimeter 102op of robot 100 comes into contact with an object (e.g., a wall, baseboard, or furniture) within the environment in which robot 100 is moving or otherwise operating. Further, FIG. 1 illustrates wheel 256w1, which a first wheel of robot 100. Additional figures herein (e.g., FIG. 2B) further describe example wheels of the robot 100 herein.

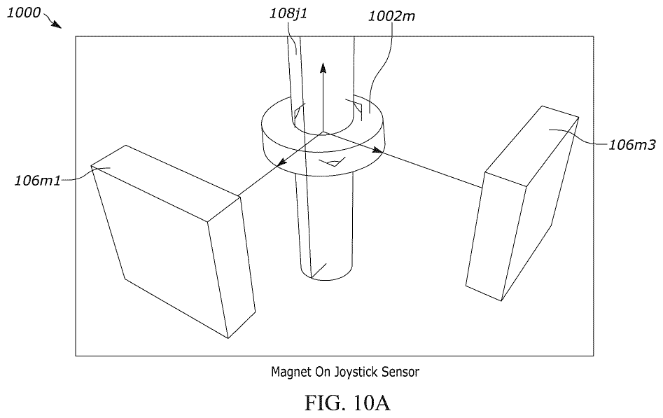

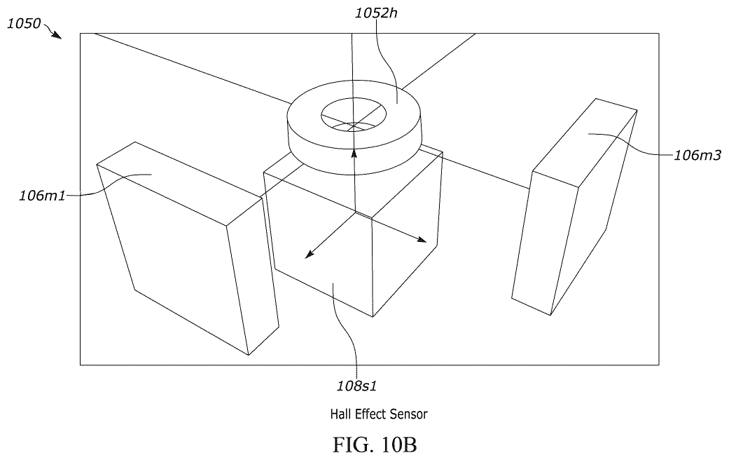

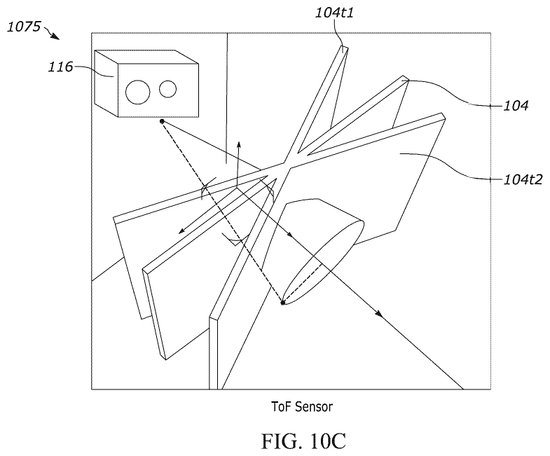

FIG. 2A illustrates an exploded view 200 of a portion of the example robot 100 of FIG. 1 in accordance with various aspects disclosed herein. In the example of FIG. 2A, body 102 of robot 100 is shown with its various components (but excluding wheels, which are further described herein with respect to additional figures, e.g., FIG. 2B). As shown for FIG. 2A, robot 100 comprises a bumper 104 configured to move relative to body 102 of robot 100. For example, bumper 104 may move towards body 102 of robot 100 when bumper 104 comes into contact with an object within an environment in which robot 100 is moving. In some aspects, bumper 104 comprises one or more magnets (e.g., any one or more of magnets 106m1, 106m2, and/or 106m3) positioned on, within, or partially within bumper 104. The magnets can be used to determine position of bumper 104 with respect to magnetic-based sensor(s) as described further herein, for example, with respect to FIG. 10A.

In further aspects, bumper 104 comprises an actuator (e.g., actuator 106a) configured to actuate one or more sensors (e.g., multi-directional sensors 108s1 and 108s2). Generally, an actuator (e.g., actuator 106a) is coupled to the one or more sensors (e.g., multi-directional sensors 108s1 and sensors 108s2) such that when bumper 104 comes into contact with an object in the environment, the actuator (e.g., actuator 106a) transfers force or otherwise provides information for detection by the one or more sensors (e.g., multi-directional sensors 108s1 and sensors 108s2). For example, when bumper 104 strikes an object, actuator 106a transfers force to multi-directional sensor 108s2 (e.g., as shown in FIG. 2C), where multi-directional sensor 108s2 is coupled to actuator 106a at actuator receiver 106ar2 (e.g., as shown in FIG. 2C). Similarly, when bumper 104 strikes an object actuator 106a transfers force to multi-directional sensor 108s1, where multi-directional sensor 108s1 is coupled to actuator 106a at actuator receiver 106ar1. The force transferred may comprise any directional force, including lateral, horizontal, and/or vertical, which may be sensed by a multi-directional sensor (e.g., multi-directional sensors 108s1 and sensors 108s2) of robot 100.

Further, in various aspects, actuator 106a may comprise various portions. For example, as shown for FIG. 2A actuator 106a may comprise portions 106ap1 and portions 106ap2, which are examples of cross arm or beam portions that, in some aspects, may form actuator 106a. The additional portions may transfer or distribute force to or among the various sensor(s) (e.g., multi-directional sensors 108s1 and sensors 108s2) thereby causing the sensor(s) to collect different data based on a location of the impact of a given object on bumper 104. For example, where actuator portion 106ap2 forms part of actuator 106a, an impact on bumper 104 nearer to actuator receiver 106ar2 would cause a greater amount of force to be transferred (across actuator portion 106ap2) to actuator receiver 106ar1. Thus, in such an example, multi-directional sensor 108s1 would sense or detect a greater degree of force (and thus generate a proportional degree of sensor data) than had actuator portion 106ap2 formed no part of actuator 106a.

As a further example, where actuator portion 106ap1 forms part of actuator 106a, an impact on a corner side of bumper 104 nearer to actuator receiver 106ar1 would cause a greater amount of force to transfer (across actuator portion 106ap1) to actuator receiver 106ar2. Thus, in such an example, multi-directional sensor 108s2 would sense or detect a greater degree of force data than had actuator portion 106ap1 formed no part of actuator 106a. It is to be understood, however, that additional, fewer, and/or different portions may be formed or otherwise configured for actuator 106a causing actuator receiver(s) (e.g., receiver 106ar1 and/or receiver 106ar2) to receive additional, fewer, and/or different force(s) thereby causing their respective sensors (e.g., multi-directional sensors 108s1 and sensors 108s2) to experience and detect different force or other data.

In this way the sensor(s) and actuator(s) can be configured together to detect various fidelities, degrees, or otherwise types of sensor data in order to configure robot 100 to sense or respond to its environment and to navigate therein.

As further shown for FIG. 2A, a sensor multi-directional sensor (e.g., multi-directional sensors 108s1 and sensors 108s2) may be installed or otherwise position on body 102 for sensing, detecting, or otherwise receiving sensor data. The example embodiment of FIG. 2A illustrates multi-directional sensor 108s1 positioned on, in, or at partially within chassis 102c of robot body 102. Multi-directional sensor 108s2 is also positioned on chassis 102c as further shown for FIG. 2C herein. The multi-directional sensor(s) may fit or be otherwise be coupled to an actuator (e.g., actuator 106a of bumper 104) by receivers (e.g., receiver 106ar1 and/or receiver 106ar2) to receive and detect force or movement, and various degree(s) or otherwise amounts thereof. It is to be understood, however, that multi-directional sensor(s) may be positioned elsewhere on body 102 of robot 100. In some examples, one or more multi-directional sensor(s) may comprise Time-of-Flight sensor(s) where such sensor(s) may be positioned on a forward portion or other portion of robot 100.

Further with respect to FIG. 2A, robot 100 comprises a circuit board 110. Battery 118 may power circuit board 110 and its various components, which may include, by way of non-limiting example, a processor 112 and a memory 114. Processor 112 may be communicatively coupled to memory 114 via a computing bus of circuit board 110. Further, Processor 112 may be communicatively coupled to the multi-directional sensor(s) (e.g., multi-directional sensors 108s1 and sensors 108s2) for receiving sensor data from the sensor(s). Processor 112 may transfer to (e.g., store), and receive (e.g. load) from memory 114 information, including computing instructions and/or data (e.g., sensor data). For example, in various aspects, memory 114 comprises a computer memory storing computing instructions (e.g., firmware) on the computer memory for execution by processor 112. Processor 112 may receive sensor data from multi-directional sensor(s) (e.g., multi-directional sensors 108s1 and sensors 108s2), where computing instructions, loaded from memory 114, cause processor 112 to analyze the sensor data causing robot 100 to implement any of the algorithms, methods, processes, steps, and/or otherwise functionality describe herein. For example, the computing instructions may cause robot 100 to navigate in an environment, respond to objects or series of objects within the environment and/or surface types (e.g., different variations in surfaces or types thereof caused by a vent, register, or other such item causing a surface irregularity or difference in a floor area that the robot is operating with respect to), including processing or otherwise interpreting sensor data to determine how to operate when the robot, or portion thereof, comes into contact with an object within the environment. In various aspects, the computing instructions may be implemented in any desired program language (e.g., C, C++, C#, C, Java, or the like), and may be interpreted or executed as program code, machine code, assembly code, byte code, or the like.

Circuit board 110 may further comprise a Time-of-Flight (ToF) sensor 116 that may be positioned to scan, image, or detect an interior surface of robot 100, such as the interior surface of bumper 104. The ToF sensor 116 may scan the bumper 104 surface several times per second to determine a distance or magnitude of travel of the surface of bumper 104 for the purpose of detecting, e.g., via a degree of travel or movement of the bumper surface, an impact on the bumper 104 by an obstacle in an environment in which the robot 100 moves.

FIG. 2A further illustrates a cavity 122 which comprises a wheel well for housing a wheel structure as illustrated for FIG. 2B. The wheel structure may be attached by pivot plate 124 for pivoting the wheel structure or otherwise allowing the wheels structure to move, dampen, and/or respond to floor surface(s) and/or obstacles.

Robot 100 may further comprise a button 105b that when depressed activates a switch 105s. Switch 105s may be communicatively coupled to processor 112, such that when pressed, sends a single causing processor 112 to perform various functions, including turning a state of the robot on, off, cycling through various modes of operation of the robot, and/or otherwise implementing any of the algorithms, flowcharts, or instructions as described herein.

FIG. 2B illustrates a further exploded view 250 of the example robot 100 of FIG. 1 in accordance with various aspects disclosed herein. In the example of FIG. 2B, wheels of robot 100 are shown with various components. These components are configured to fit or otherwise be installed into cavity 122 of robot 100 and attached to pivot plate 124, as described herein for FIG. 2A. For example, the wheel structure as shown for FIG. 2A may comprise a wheelbase 252 configured to receive (e.g., via screws) motor 254m1 and motor 254m2. Each of motors 254m1 and 254m2 may couple to (e.g., be positioned within or partially within) wheels 256w1 and 256w2. Each of motors 254m1 and 254m2 may comprise electric motors (e.g., a 12-volt direct current (DC) motor) that may comprise a gearbox and/or shaft(s) for rotating a turning a wheel or tire, e.g., via a cogged base wheel, such as shown for each of wheels 256w1 and 256w2. By way of non-limiting example, motors 254m1 and 254m2 may be brush or brushless motor(s) having gear assemblies and electronics for rotating the wheels when a power source is applied (e.g., battery 118). It is to be understood, however, that additional, fewer, and/or different motor(s) or types thereof may be used to move or drive robot 100.

Wheelbase 252 as shown for FIG. 2A may be attached (e.g., via screw(s)) to pivot plate 124 of robot 100 allowing the wheelbase (e.g., and thus wheels 256w1 and 256w2) to tilt and/or pivot, which allows the wheel structure, as a whole, to respond to a floor surface and/or variances thereof (caused by a non-level floor, bumps, etc.) of an environment by absorbing shock or conforming to the floor or otherwise variance.

As shown for FIG. 2B, motor 254m1 and motor 254m2 may be coupled to wheel 256w1 and wheel 256w2 respectively. Motor 254m1 is configured to drive or rotate wheel 256w1 forward and backward. Likewise, motor 254m2 is configured to drive or rotate wheel 256w2 forward and backward. Processor 112 may be communicatively coupled to each of the motor(s) to send signals to cause the motors to drive, actuate, or otherwise move robot 100 in various directions or manners (e.g., forward, backward, rotating, etc.) within a given environment.

FIG. 2C illustrates a top-down cross-sectional view 270 of the example robot of FIG. 1 in accordance with various aspects disclosed herein. Robot 100 comprises an example robotic configuration comprising two sensors, that is, a first sensor and a second sensor, which may each comprise multi-directional sensors as shown embedded or at least partially within chassis 102c. In particular, as illustrated for FIG. 2C, robot 100 includes multi-directional sensor 108s1 and multi-directional sensor 108s2. In various aspects, processor 112 may execute computing instructions, stored in memory 114, that when executed by the processor, cause processor 112 to receive first sensor data from multi-directional sensor 108s1 and/or second sensor data from multi-directional sensor 108s2 when at least a portion (e.g., bumper 104) of the outer perimeter (e.g., outer perimeter 102op) of the body 102 contacts an object (e.g., obstacle 804) in a given environment (e.g., environment 800). The first and/or second sensor data may be analyzed by processor 112, which may respond by actuating a motor (e.g., motor 254m1 and/or motor 254m2) based on the first and/or second sensor data to cause the robot to alter its course in the environment (e.g., example environment 800) in order to navigate or traverse the obstacle (e.g., obstacle 804).

In the example of FIG. 2C, each of multi-directional sensor 108s1 and multi-directional sensor 108s2 are coupled to at least a portion of the outer perimeter 102op via a multi-axis sensor actuator (e.g., actuator 106a) . More generally, a given sensor (e.g., multi-directional sensor 108s1 and/or multi-directional sensor 108s2) may be coupled to a portion of the robot (e.g., bumper 104) that forms an outer perimeter thereof. In various aspects, a multi-axis sensor actuator (e.g., actuator 106a) is a structure that moves or otherwise actuates the sensors(s) (e.g., multi-directional sensor 108s1 and/or multi-directional sensor 108s2). In some aspects, the multi-axis sensor actuator (e.g., actuator 106a) is a dampening structure, which may be formed of one or more areas, portions, or frame types. For example, the multi-axis sensor actuator (e.g., actuator 106a) is shown with various example portions 106ap1 and 106ap2, which may or may not form part of the multi-axis sensor actuator (e.g., actuator 106a). The additional portions 106ap1 and/or 106ap2 may be added or removed to the multi-axis sensor actuator (e.g., actuator 106a) so as to provide different force(s) across the physical structure of actuator 106a as a whole. For example, adding portion 106ap1 and/or 106ap2 can cause sensors (e.g., multi-directional sensor 108s1 and/or multi-directional sensor 108s2) to experience additional force when the force is transferred from bumper 104 (after striking an object) across portion(s) 106ap1 and/or 106ap2 to respective actuator receiver 106ar1 and/or actuator receiver 106ar2, and ultimately to respective sensors (e.g., multi-directional multi-sensor 108s1 and/or multi-directional sensor 108s2) for generation of corresponding sensor data.

Still further, the material properties of the multi-axis sensor actuator (e.g., actuator 106a) and/or its portions(s) 106ap1 and/or 106ap2 may impact or otherwise influence the amount or degree of force, and thus, amount or degree of sensor data, generated by the sensor(s). That is, in various aspects the multi-axis sensor actuator 106a (and/or portions thereof) may be configured to be deformed in a shape such that a deformation of the shape can create a change in sensor data as output by at least one sensor (e.g., multi-directional sensor 108s1 and/or multi-directional sensor 108s2). For example, a dampening effect of a given dampening structure come from the physical material (e.g., plastic) of the multi-axis sensor actuator itself where the property of plastic(s) and the deformation behavior of plastics in general may, at least in some aspects, provide dampening and/or elasticity. It is to be understood that the multi-axis sensor actuator need not be perfectly elastic. In various aspects, the multi-axis sensor actuator can be rigid or flexible. Additionally, or alternatively, the multi-axis sensor actuator (e.g., actuator 106a) can be linear or non-linear with respect to flexibility, but at the same time be configured to actuate one or more sensor(s). For example, the multi-axis sensor actuator (e.g., actuator 106a) as a dampening structure may be coupled to multi-directional sensor 108s1 and second multi-directional sensor 108s2 but be configured to be sufficiently rigid to move multi-directional sensor 108s1 and/or multi-directional sensor 108s2 when a force is applied to the multi-axis sensor actuator (e.g., actuator 106a). Such force may comprise when at least a portion of the outer perimeter (e.g., outer perimeter 102op) of body 102 of robot 100 contacts an object (e.g., obstacle 804) in the environment (e.g., environment 800). For example, in some aspects, the multi-axis sensor actuator (e.g., actuator 106a) is formed of a material (e.g., a plastic) that is sufficiently rigid to apply actuation force(s) to one or more of the sensor(s) (e.g., multi-directional sensor 108s1 and/or the second multi-directional sensor 108s2) so as to apply a degree of force in proportion to the sensor(s) in order to move, or otherwise interact with, the sensor(s) and thus cause sensor data to be generated therefrom.

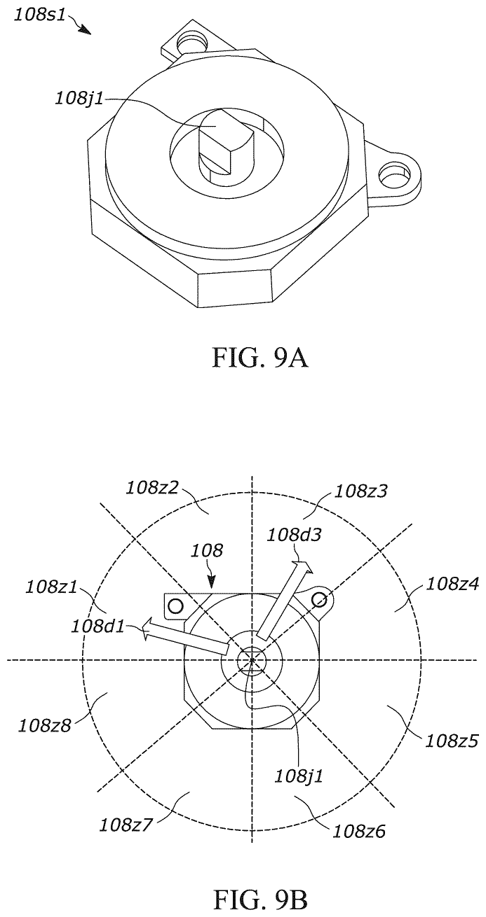

In the example of FIG. 2C, multi-directional sensor 108s1 and/or multi-directional sensor 108s2 may comprise joystick type sensors that generate respective sensor data when force is applied to a joystick (e.g., 108j1 as shown for FIG. 9A) of the sensor. For example, a joystick (e.g., joystick 108j1) of multi-directional sensor 108s1 may connect or otherwise couple to actuator receiver 106ar1, where actuator receiver 106ar1 pushes or otherwise actuates the joystick portion of multi-directional sensor 108s1 when bumper 104 hits an object in an environment (e.g., example environment 800). Actuation of the joystick sensor (or otherwise multi-directional sensor 108s1) causes the sensor to generate sensor data (e.g., in a degree proportional to the amount of travel of the joystick) that is then provided to processor 112 and/or 114 for processing, analysis, and/or storage, for example, as described herein. In some aspects, multi-directional sensor 108s2 may also be a joystick sensor that operates in as same or similar manner as described for multi-directional sensor 108s1.

In various aspects, each of the multi-axis sensor actuator (e.g., 106a), multi-directional sensor 108s1, and multi-directional sensor 108s2 together comprise or form a synthetic sensor. In such aspects, computing instructions stored on the computer memory 114, when executed by processor 112, are configured to cause processor 112 to generate synthetic sensor data based on first sensor data of as received by multi-directional sensor 108s1 and/or second sensor data as received by multi-directional sensor 108s2. For example, in some aspects, synthetic sensor data may comprise data computed and/or combined using each of the first sensor data and the second sensor data even though the sensor data and the second sensor data may differ based on at least one of direction and/or magnitude. Synthetic sensor data may be calculated, generated, or otherwise determined by averaging, taking a derivative of, taking weights of, or otherwise combining the first sensor data and the second sensor data of multi-directional sensor 108s1 and multi-directional sensor 108s2. Such data may be generated when the sensor(s) are actuated as part of multi-axis sensor actuator (e.g., 106a) when robot 100 (e.g., bumper 104) strikes an object (e.g., obstacle 804).

In addition, in some aspects multi-axis sensor actuators (e.g., actuator 106a) are configured to actuate separate sensor(s) separately or independently. For example, actuator 106a could be configured to actuate multi-directional sensor 108s1 and/or multi-directional sensor 108s2 separately or independently by disassociating or otherwise eliminating portions (e.g., actuator portion 106ap1 and/or actuator portion 106ap2) of the bumper 104. For example, in some aspects, bumper 104 may be configured to have multiple independent portions that move freely with respect to one another and thus separately actuate related sensor(s) that are coupled to respective actuator receiver(s).

Still further, additionally or alternatively, in some aspects, multi-axis sensor actuator (e.g., actuator 106a and portions thereof such as actuator portion 106ap1 and/or actuator portion 106ap2) is limited to one more directions and/or one or more distances of travel within or with respect to the body 102 of robot 100 to prevent actuating at least one of the multi-directional sensor (e.g., multi-directional sensor 108s1) or the second multi-directional sensor (e.g., multi-directional sensor 108s2) to a fully actuated position. For example, in such aspects, by preventing or avoiding actuating a multi-directional sensor to a fully actuated position, the longevity and/or operation of the multi-direction sensor, as well as its data fidelity, may be improved, thereby improving and/or prolonging the accuracy and operating efficiency of the robot itself.

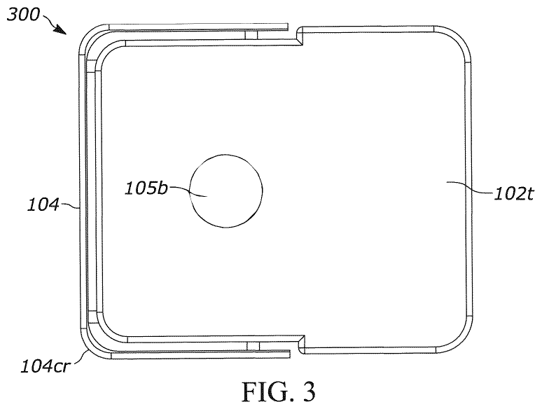

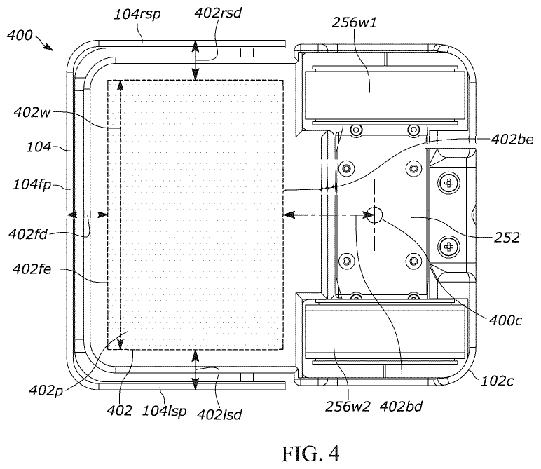

FIG. 3 illustrates a top view 300 of the example robot 100 of FIG. 1 in accordance with various aspects disclosed herein. FIG. 3 illustrates bumper 104 and top 102t of body 102 of robot 100 as viewed from above. The bumper 104 may be comprised of a corner radius (e.g., corner radius 104cr) configured to maximize, or least enlarge, an area of the cleaning element (e.g., cleaning element 402 as described for FIG. 4).

FIG. 4 illustrates a bottom view 400 of the example robot of FIG. 1 in accordance with various aspects disclosed herein. FIG. 4 illustrates bumper 104 and chassis 102c of body 102 of robot 100 as viewed from below. Further, FIG. 4 illustrates wheelbase 252 as well as wheels 256w1 and wheels 256w1 as viewed from below. Still further, FIG. 4 illustrates a cleaning element 402 that may be attached to body 102 of robot 100. Such cleaning element may comprise a substate mount (e.g., a VELCRO-based mount or a grommet-based mount) for receiving and holding a disposable hard surface wiping substate (e.g., cleaning pad 402p) to the underside of robot 100. The cleaning element 402 or substate mount may include a width (e.g., width 402w). Cleaning element 402 may be used to vacuum, mop, sweep, disinfect, and/or apply a cleaning solution to the floor as robot 100 moves within an environment (e.g., environment 800). The cleaning element 402 may be pivotably connected to the body 102 of the robot 100. The pivotable connection can allow the cleaning element to accommodate variations in the floor surface that occur from side to side and/or from front to back of the cleaning pad 102. Additionally, to increase the cleaning efficacy of the robot, the cleaning element 402 may translate with respect to the body 102 such that the cleaning element 402 extends past at least one side of the robot body 102. It is worth noting that the translation feature may be configured to allow the cleaning element to translate in a first direction and a second direction opposite the first. At least in one non-limiting example, cleaning element 402 may comprise, otherwise be configured to fit, a SWIFFER brand cleaning element or pad (e.g., as represented by cleaning pad 402p), including variants thereof, as manufactured or provided by THE PROCTER & GAMBLE COMPANY (P&G).

Still further, with respect to FIG. 4, the robot may comprise a center of rotation (e.g., center of rotation 400c). The robot may further comprise a turn radius, which can be measured based on a distance (e.g., distance 402bd) between a back edge of a portion (e.g., back edge 402be) of cleaning element 402 (e.g., the back edge cleaning pad 402p attached to or as part of cleaning element 402) and the center of rotation (e.g., center of rotation 400c).

In addition, as shown for FIG. 4, bumper 104 comprises a front bumper portion 104fp, a right-side bumper portion 104rsp, and a left-side bumper portion 104lsp. It is to be understood that additional and/or different bumper portions, areas, or zones may be defined for bumper 104.

Further, as shown for FIG. 4, cleaning element 402, or a portion thereof (e.g., a cleaning pad) may be positioned in proximity to bumper 104. As shown, front side bumper distance 402fd is a distance between front bumper portion 104fp and a front edge 402fe of cleaning element 402, or a portion thereof (e.g., a cleaning pad). Similarly, right side bumper distance 402rsd is a distance between right bumper portion 104rsp and a right-side edge of cleaning element 402, or a portion thereof (e.g., a cleaning pad). Further, left side bumper distance 402lsd is a distance between left bumper portion 104lsp and a left-side edge of cleaning element 402, or a portion thereof (e.g., a cleaning pad).

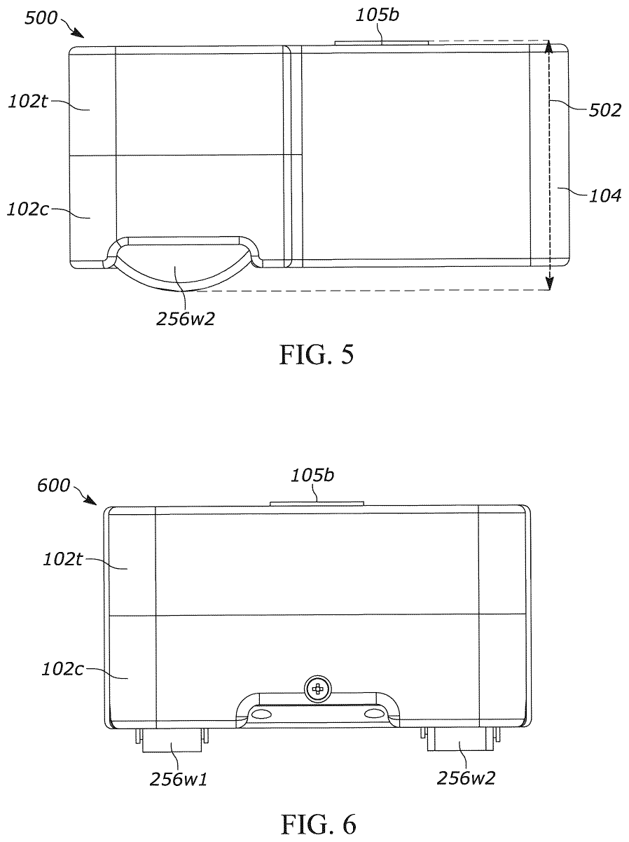

FIG. 5 illustrates a side view 500 of the example robot of FIG. 1 in accordance with various aspects disclosed herein. FIG. 5 illustrates bumper 104, chassis 102c and top 102t of body 102, and wheel 256w2 as viewed from a side of robot 100. The robot 100 may comprise a height 502, which may be measured from a bottom of a wheel (e.g., wheel 256w2) to a top portion of the robot 100.

FIG. 6 illustrates a rear view 600 of the example robot 100 of FIG. 1 in accordance with various aspects disclosed herein. FIG. 6 illustrates chassis 102c and top 102t of body 102, as well as wheels 256w1 and 256w2 as viewed from the rear of robot 100.

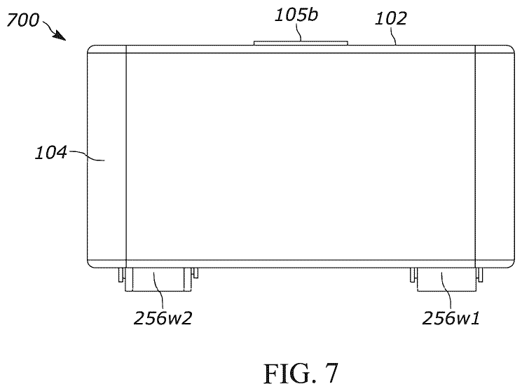

FIG. 7 illustrates a front view of the example robot 100 of FIG. 1 in accordance with various aspects disclosed herein. FIG. 7 illustrates bumper 104 as well as wheels 256w1 and 256w2 as viewed from the front of robot 100.

FIG. 8 illustrates an example environment 800 in which the robot of FIG. 1 can navigate or otherwise move within in accordance with various aspects disclosed herein. Environment 800 illustrates an example room (e.g., a living room) comprising an obstacle 804 (e.g., furniture) having two portions (e.g., legs) around which robot 100 must navigate or move. As shown in the example of figure, robot is programmed to move in linear forward back-and-forth motion to clean environment 800. As the robot encounters obstacle 804, robot 100 is able to navigate accordingly. For example, bumper 104 may come into contact with obstacle 804 (e.g., furniture) causing force to be detected by sensor(s) (e.g., multi-directional sensors 108s1 and 108s2). Sensor data may be sent to processor 112, which executes computing instructions to drive wheels of robot (e.g., wheels 256w1 and/or 256w2) to operate robot to move around or otherwise traverse obstacle 804 to allow robot 100 to continue its forward navigation, and therefore cleaning of environment 800.

### Robotic Sensor Control

FIG. 9A illustrates an example multi-directional sensor (e.g., multi-directional sensor 108s1) in accordance with various aspects disclosed herein. In the example of FIG. 9A, multi-directional sensor is an analog sensor, such as a joystick sensor. It is to be understood, that multi-directional sensor 108s1 may, in other aspects, comprise a different type of sensor, for example as described herein. As shown for FIG. 9A, multi-directional sensor (e.g., multi-directional sensor 108s1) comprises a joystick 108j 1 that when moved or otherwise actuated, causes multi-directional sensor 108s1 to generate sensor data to a degree and/or magnitude associated with a distance and/or direction of travel of the joystick 108j1. For example, in various aspects, when joystick 108j1 is moved or otherwise actuated by actuator 106a through actuator receiver 106ar1, multi-directional sensor 108s1 generates sensor data. Processor 112 receives the sensor data from the multi-directional sensor 108s1. This can occur, for example, when at least a portion of the outer perimeter of the body of the robot contacts an object in an environment (e.g., environment 800). Processor 112, analyzing the sensor data, can then actuate the motor (e.g., motor 254m1 and or motor 254m2). Because the sensor data differs based on the degree of travel of the joystick (or degree of difference in the change based on the sensor type), the sensor data comprises high fidelity sensor data that can be used measure (e.g., based on the degree of travel of the joystick) various proportional degrees of contact or otherwise interactions with obstacles in the environment 800. Such high-fidelity data allows processor 112 of robot 100 to maneuver, alter its course, or otherwise operate in highly sensitive and/or highly specific manners for cleaning in small spaces, spaces having low angled areas, tight corners, or the like. The high-fidelity sensor data allows, for example, the robot to maneuver its cleaning element 402 (e.g., comprising cleaning pad) into and/or up to boundary edges (e.g., walls or otherwise edges) of an environment. At the same time, the high-fidelity sensor data allows for the robot to be operated so as to have a low impact (e.g., gentle interaction) with obstacles or walls in the environment (e.g., to avoid damaging the obstacle when it is struck by the robot). This could include, for example, precluding or mitigating damage to paint on baseboards, wood on furniture legs, etc.

Still further, in some aspects, a sensor (e.g., multi-directional sensor 108s1) may be limited to one more directions of travel and/or one or more distances of travel within or with respect to the body of the robot 100 to prevent a sensor or portion thereof (e.g., joystick 108j1) to move to a fully actuated position. That is, a joystick or otherwise high-fidelity sensor portion, may be prevented, e.g., by an actuator (e.g., actuator 106a as described herein) from traveling to the joystick's maximum physical distance. Travel to a maximum distance may place stress on the sensor or its components (e.g., springs in the joystick sensor). By preventing or avoiding actuating a multi-directional sensor to a fully actuated position, the longevity and/or operation of the sensor, as well as its data fidelity, may be improved or extended, thereby improving and/or prolonging the accuracy and operating efficiency of the robot itself.

FIG. 9B illustrates the example multi-directional sensor of FIG. 9A with an example plurality or set of radial zones (e.g., zones 108z1-108z8) in accordance with various aspects disclosed herein. Generally, sensor data may be analog or otherwise raw sensor data that does not define discrete or otherwise digital-based directions. FIG. 9B illustrates that, at least in some aspects, the sensor data may be formatted, augmented, defined or otherwise determined as directional sensor data that indicates discrete or otherwise zone-based direction(s) in which a multi-directional sensor was actuated towards or with respect to. Each radial zone can then be used to define a given direction relative to the robot 100.

As shown for FIG. 9B, multi-directional sensor 108s1 comprises eight (8) discrete zones (e.g., zones 108z1-108z8). It is to be understood, however, that additional, fewer, or different zones may also be utilized. For example, in one aspect, the plurality of radial zones may comprise at least two radial zones. Still further, in some aspects, the plurality of radial zones are configurable or otherwise adaptable to have a specified number of radial zones (e.g., 16 or 32 zones), where an increase in zones allows the sensor to report or otherwise determine a higher degree of zone activity defining the position of joystick 108j1 and thus allowing robot 100 more finite and discrete control within an environment (e.g., environment 800). Still further, in some aspects, such zones need not be uniform in size(s) and/or degree(s). Additionally, or alternatively, such zones need not be radial but can be configured to have or otherwise comprise different shapes or patterns.

When joystick 108j1 is at rest (i.e., not actuated) then a multi-directional sensor(s) can provide sensor data reporting a zero-position. In some aspects, the zero-position is set by the robot 100 when it powers on, where the robot determines an initial position of the multi-directional sensor (e.g., when at rest) as constituting the zero-position. Such procedure can be performed for each power cycle of the robot 100 (e.g., when the robot 100 is turned on and off). When 108j1 is moved in a given direction (e.g., direction 108d1) then multi-directional sensor 108s1 can provide, report, or send sensor data to processor 112 for analysis. Processor 112 can then execute its computing instructions to determine which zone the sensor data belongs to, e.g., zone 108z1 for direction 108d1. As a further example, when 108j1 is moved in direction 108d3 then multi-directional sensor 108s1 can provide, report, or send sensor data to processor 112 for analysis, where processor 112 can execute its computing instructions to determine that the sensor data belongs to zone 108z3. In this way, processor 112 can determine whether sensor data belongs to any of the given zones (e.g., zones 108z1-108z8). Such zone information and/or determination can then be used to drive or otherwise manipulate the robot 100 (e.g., by moving the robot 100 in environment 800).

Further, for each sensor, the sensor's respective sensor data can be based on the sensor's location relative to the robot 100 and/or it's body 102. For example, multi-directional sensor 108s1 may be located on a side of the robot, where processor 112 executes programming instructions that factor in multi-directional sensors 108s1's position relative to the robot 100 and/or it's body 102, in addition to other factors, such as actuator 106a's impact on multi-directional sensor 108s1 based on the position of actuator 106a (and/or its portions), the material propertie(s) of actuator 106a, and/or the direction of travel of joystick 108j1 based on such impact, configuration, structure, or otherwise setup of the overall mechanism of these components relative to multi-directional sensors 108s1.

FIGS. 10A-10C illustrates example sensors that may be used in addition to, or in the alternative to, the analog and/or joystick sensors as described for FIGS. 9A and 9B herein.

FIG. 10A illustrates an example magnetic-based multi-directional sensor configuration 1000 in accordance with various aspects disclosed herein. In the example of FIG. 10A, the multi-directional sensor is configured such that a magnet 1002m is attached to joystick 108j1 of multi-directional sensor 108s1. In such aspects, multi-directional sensor 108s1 comprises a magnetic field sensor such that one or more magnets (e.g., magnets 106m1-106m3) are positioned on the outer perimeter 102op (e.g., bumper 104) of robot 100 to provide magnetic signals. In such aspects, the magnetic field sensor (e.g., multi-directional sensor 108s1) of magnetic-based multi-directional sensor configuration 1000 generates the sensor data based on the magnetic signals provided by the one or more magnets (e.g., magnets 106m1-106m3) when an object strikes the outer perimeter 102op (e.g., bumper 104) of robot 100. For example, as shown for FIGS. 2A and 2C, magnets 106m1-106m3 are positioned on a surface (e.g., an interior surface or partially embedded surface of bumper 104) of the robot 100 to provide magnetic signals such that the magnets travel closer or further from the joystick 108j1 and magnet 1002m as bumper 104 is struck by a given object. The magnetic field sensor (e.g., multi-directional sensor 108s1) can then generate sensor data, for receipt by processor 112, based on the magnetic signals. More generally, the magnets that make up the magnetic field can be positioned on robot 100 in various locations, e.g., the magnetic field sensor could be on or in the body of the robot with the magnets on the outer perimeter 102op of the robot body (e.g., magnets on bumper 104 as illustrated for FIG. 2A), or, in the alternative, the magnetic field sensor could be on the bumper structure, with the magnets inside the robot body 102 (not shown).

FIG. 10B illustrates an example Hall-effect-based multi-directional sensor configuration 1050 in accordance with various aspects disclosed herein. As shown in FIG. 10B, a multi-directional sensor 108s1 may comprise a Hall-effect type sensor. Generally, a Hall-effect sensor (e.g., multi-directional sensor 108s1) of Hall-effect-based multi-directional sensor configuration 1050 may comprise a type of transducer configured to detect the presence or absence of a magnetic field. The magnetic field can be created by one or more magnets (e.g., magnets 106m1-106m3) that are positioned on the outer perimeter 102op (e.g., bumper 104) of robot 100 to provide magnetic multi-directional sensor 108s1 may detect the generation of a voltage difference (i.e., a Hall voltage) across a conductor or semiconductor of multi-directional sensor 108s1 when it is subjected to the magnetic field. The voltage is proportional to the strength of the magnetic field and can be measured as an output signal. The output signal may comprise (e.g., can be interpreted as, or cause to be generated) sensor data that can be provided to processor 112 for analysis and processing to move or navigate robot 100 as described herein.

FIG. 10C illustrates an example Time-of-Flight (ToF)-based multi-directional sensor configuration 1075 in accordance with various aspects disclosed herein. FIG. 10C illustrates ToF sensor 116 as a multi-directional sensor. ToF sensor 116 measures the distance between ToF sensor 116 and an object (e.g., bumper 104) by determining the time it takes for a light signal or a laser pulse to travel to the object and back to the sensor. More generally, a TOF sensor operates based on the principle of measuring the time it takes for light to travel a certain distance. A given ToF sensor will emit a light signal, such as a laser pulse or an infrared beam, and then measure the time it takes for the signal to be reflected back to the sensor. By using the known value of the speed of light, a ToF sensor (e.g., ToF sensor 116) can calculate the distance to the object. ToF sensor 116 can then use the information regarding the reflected light to generate 3D sensor data defining the object that the light was reflected off of.

As shown for FIG. 10C, multi-directional sensor 116 is configured to send and receive signals (e.g., such as light represented by field of view cone) to an interior surface of robot 100 (e.g., bumper 104). The surface (e.g., bumper 104) may change angles or otherwise be deformed when it comes into contact with an object (e.g., obstacle 804) of an environment (e.g., environment 800). For example, surface 104t1 represents a surface of bumper 104 at a first time and surface 104t2 represents a surface of bumper 104 at a second time when bumper 104 is being moved or otherwise deformed when robot 100 strikes an object (e.g., obstacle 804). The ToF sensor 116 can detect light bounced off bumper 104 and generate 3D sensor data associated with the amount and direction of the movement or deformation of bumper 104. Such 3D sensor data can then be provided to processor 112 for processing and/or analysis described herein. That is, in some aspects, sensor data comprises three-dimensional (3D) sensor data as detected and generated by a ToF sensor (e.g., ToF sensor 116) of one or more interior surfaces of the body of the robot (e.g., one or more interior surfaces of bumper 104). In such aspects, the 3D sensor data can define a distance of the one or more interior surfaces of the body of the robot with respect to the ToF sensor that processor 112 can use to determine an impact or movement of the given surface area, and then move or navigate robot 100 in response thereto.

### Robot Navigation Strategies

Robotic cleaning may comprise navigation strategies implemented by a robot (e.g., robot 100) executing algorithms or computing instructions stored in its memory (e.g., memory 114). In various aspects, a robot configured for cleaning and/or navigation comprises a body (e.g., robot body 102) having a chassis (e.g., chassis 102c) and a cleaning element (e.g., cleaning element 402). The robot may comprise a motor (e.g., motor 254m1 and/or motor 254m2) configured to move the robot (e.g., robot 100) within an environment (e.g., environment 800).

The robot may further comprise a sensor. The sensor may include a force-based sensor (e.g., an analog sensor or a joystick sensor as described herein for FIG. 9A and/or 10A). However, it is to be understood, that the sensor may comprise a different sensor type including, by way of non-limiting example, a magnetic-based sensor (e.g., a magnetic field or Hall-effect sensor as described herein for FIGS. 10A and 10B). Additionally, or alternately, the sensor may comprise an image-based sensor or light-based sensor (e.g., ToF sensor 116) as described herein for FIG. 10C.

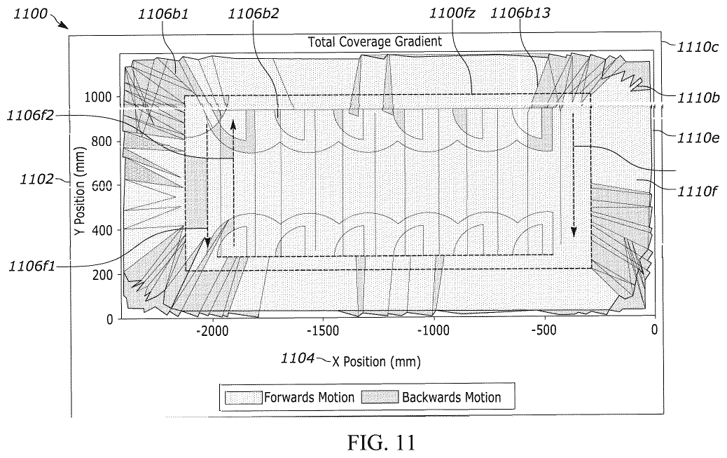

The robot may further comprise a processor (e.g., processor 112) communicatively coupled to the sensor and a computer memory (e.g., memory 114) communicatively coupled to the processor. The computing instructions, when executed by the processor (e.g., processor 112), may cause the processor to navigate or alter the course of the robot within the environment (e.g., environment 800), for example, as described herein for FIGS. 11-16. The maneuvering, altering of course, or otherwise navigation strategy increases cleaning efficiency by minimizing particle drop (i.e., debris falloff) because the robot is configured to maintain or maximize a forward movement or forward moving direction. The forward movement or forward moving direction allows the cleaning element 402 (e.g., its cleaning pad) to capture and push debris in a continuous direction so as to hold the debris in the pad (e.g. cleaning pad 402p). Similarly, the navigation strategy minimizes any reverse movement or reverse direction in order to prevent or minimize backing up or reversing direction, which can cause the cleaning element 402 (e.g., comprising its cleaning pad 402p) to experience debris falloff or particle drop.

FIG. 11 illustrates a coverage diagram 1100 showing example navigation or movement of a robot (e.g., robot 100) within an environment in accordance with various aspects disclosed herein. In particular, FIG. 11 shows coverage plot or diagram showing a path that a robot (e.g., robot 100) moved or navigated within a given environment. For example, the environment may comprise or represent a top-down view of environment 800. In various aspects, including in the example of FIG. 11, the robot (e.g., robot 100) operates in different modes related to cleaning different areas of an environment 800. For example, a robot (e.g., robot 100) may operate to clean one or more edge(s) (e.g., walls) of an environment 800 as demonstrated, for example, by forward movement 1110f. A s a further example, a robot (e.g., robot 100) may operate to clean a fill zone 1100fz, which may comprise a non-edge area of an environment (e.g., a center or middle area of an environment 800), which may be represented, for example, by areas shown for forward movements of the robot (e.g., forward movements 1106f1-1106f13).

In the example of FIG. 11, the environment is defined or mapped according to a Y-Position 1102 and an X-Position 1104 defining the robot's movement within the environment 800. The positions are measured in millimeters (mm), although it is to be understood that different position values and/or measurements may be used to identify a robot's position within a given environment.

As demonstrated in the example of FIG. 11, robot 100 moves, at least in one aspect, in a zig-zag type pattern, or, otherwise back-and-forth type pattern comprising forward movement 1106f1, forward movement 1106f2, and so forth including forward movement 1106f13. It is to be understood, however, that different movement patterns are contemplated herein. Each of the forward movements (e.g., forward movements 1106f1-1106f13) comprises a forward direction or otherwise forward motion relative to a cleaning element (e.g., cleaning element 402) of the robot (e.g., robot 100), where the cleaning element 402 is positioned in a front portion of the robot 100. In this way, the robot (e.g., robot 100) moves forward and thereby cleans a center or middle portion of the environment 800. FIG. 11 also shows example backward movements 1106b1, 1106b2, and 1106b13, which occurred before or after forward movements 1106f1, 1106f2, and 1106f13. That is, backward movements 1106b1-1106b13 illustrate instances at which the robot (e.g., robot 100) was moving backwards relative to its cleaning element (e.g., cleaning element 402) for example in order to implement a turning or maneuver to begin a transition from one forward movement to another (e.g., forward movement 1006f1 to 1006f2).

FIG. 11 further exemplifies a navigation or movement of a robot (e.g., robot 100) involving an edge-follow or otherwise wall-follow algorithm. This is illustrated, for example, by forward movement 1110f and backward movement 1110b. As shown for FIG. 11, robot 100 follows an edge 1110e edge (e.g., a baseboard or otherwise wall or obstacle) of the environment (e.g., environment 800). Robot 100 moves in a forward direction (e.g., forward movement 1110f) relative to its cleaning element (e.g., cleaning element 402) thereby cleaning near or along 1110e edge (e.g., a wall). When robot 100 approaches corner 1110c (e.g., a corner of the environment such as two adjoining walls), then robot 100 engages or implements backward movement 1110b in order to rotate or otherwise alter its direction to continue moving in a forward direction (x-position direction) relative to the wall. In this way, robot 100 can clean a perimeter of the environment along one or more edges to ensure cleaning, disinfecting, or otherwise improvement occurs not only with respect to the center of the environment (e.g., forward movements 1106f1-1106f13), but also with respect to the edges of the environment (e.g., environment 800).

In order to accomplish the forward and/or backward movements (e.g., forward movements 1106f1-1106f12 and 1100f, backward movements 1106b1-1106b13 and 1110b) as illustrated for FIG. 11, processor 112 of robot 100 executes computing instructions, stored in memory 114. The computing instructions, when executed, cause processor 112 to actuate a motor (e.g., motor 254m1 and/or motor 254m2) to drive the robot 100 in a forward direction (e.g., forward movements 1106f1-1106f12 and 1100f) relative to the cleaning element (e.g., cleaning element 402). Further, the computing instructions, when executed, cause processor 112 to receive sensor data from a sensor (e.g., multi-directional sensor 108s1 and/or multi-directional sensor 108s2). The sensor data may indicate an object in the environment (e.g., environment 800) relative to the robot 100, for example, when the robot 100 strikes or other interacts with an obstacle 804, such as furniture or a wall within the environment. Still further, the computing instructions, when executed, cause processor 112 to actuate the motor (e.g., motor 254m1 and/or motor 254m2) based on the sensor data to cause the robot (e.g., robot 100) to alter its course while maintaining the forward direction relative to the cleaning element (e.g., cleaning element 402). Thus, the robot 100 can experience an increased amount of forward movement compared to backward movement (e.g., backward movements 1106b1-1106b13 and 1110b).

In this way, the cleaning element 402 is able to hold or otherwise collect debris as the robot 100 moves. In particular, in such aspects, robot 100 moving the cleaning element 402 is configured to hold or collect debris 1406 (e.g., as illustrated for FIG. 14) as the robot 100 moves in the forward direction (e.g., forward movements 1106f1-1106f12 and 1100f). By contrast, robot 100 may experience debris loss or falloff when it moves in a backward direction (e.g., backward movements 1106b1-1106b13 and 1110b). Thus, an algorithm implemented by processor 112 seeks to maximize debris 1706 retention and collection by maximizing a total forward amount that robot 100 experiences for any given cleaning session. For example, at least in some aspects, robot 100, when moving the cleaning element 402 in a given environment (e.g., environment 800) is configured to hold or collect at least 90 percent of a total amount of debris 1406 acquired or otherwise experienced by the cleaning element (e.g., cleaning element 402) as the robot moves in the forward direction. The given total amount of debris can be an amount of debris that is acquired or otherwise experienced by the robot during a cleaning session of the robot. A cleaning session may comprise, by way of non-limiting example, a duty cycle of the robot, a time to clean a given environment (e.g., a room), and/or a given period of time of cleaning (e.g., 10 minutes, 15 minutes, or some other unit time of cleaning).

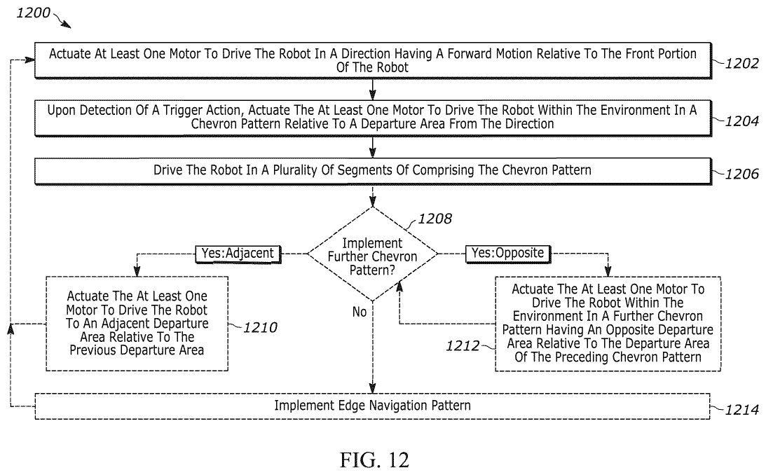

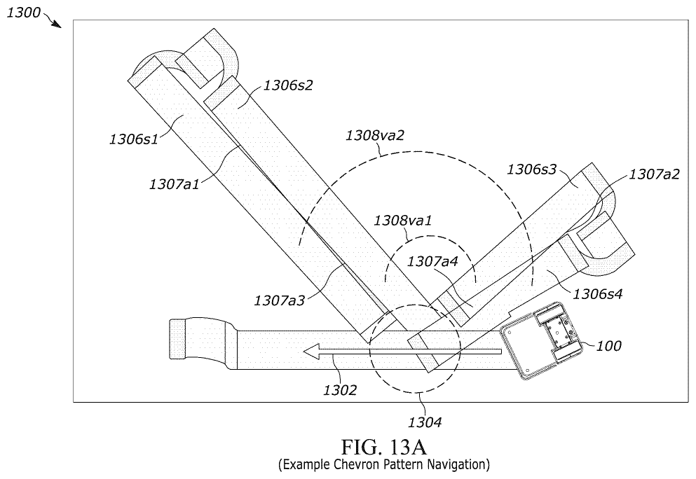

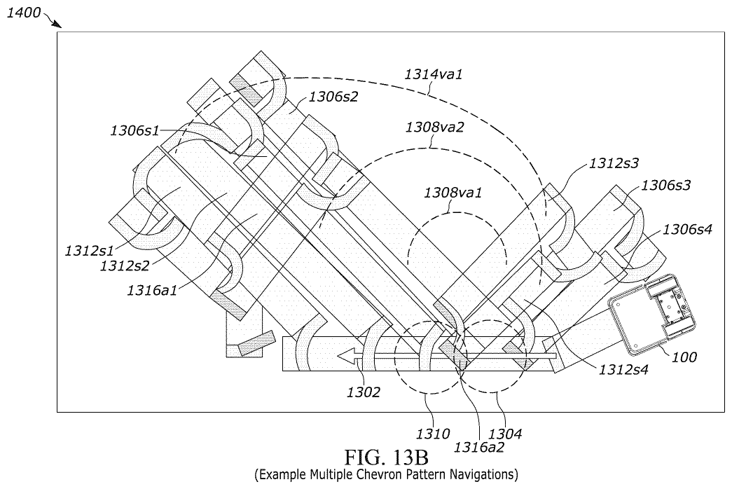

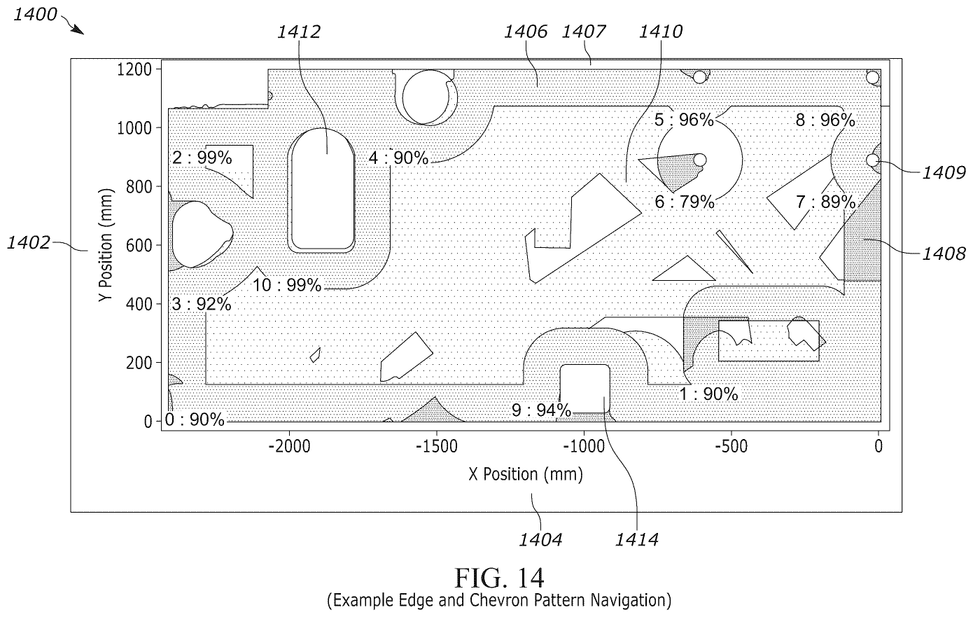

FIG. 12 illustrates a flowchart for a navigation algorithm 1200 for a robot maneuvering in one or more chevron patterns accordance with various aspects disclosed herein. Navigation algorithm 1200 of FIG. 12 is further described and depicted by FIGS. 13A and 13B, which illustrate example navigations or movements of a robot (e.g., robot 100), respectively, within an environment in accordance with various aspects disclosed herein. For example, each of FIG. 13A and FIG. 13B illustrate example respective navigation or movement of a robot in an example chevron pattern 1300 in accordance with various aspects disclosed herein.

Navigation algorithm 1200 refers to a robot (e.g., robot 100), which may comprise, as described herein, a body (e.g., body 102) comprising a chassis (e.g., 102c) and an outer perimeter (e.g., outer perimeter 102op). The body of the robot may further comprise a front portion, an opposing back portion, and a body length disposed between the front portion and the opposing back portion. The front portion may comprise a first side, an opposing second side, and a front portion width disposed between the first side and the second side (e.g., left-to-right dimension). In addition, the body may further comprise a cleaning element (e.g., cleaning element 402) positioned relative to the front portion. The robot may further comprise a motor (e.g., motor 254m1 and/or motor 254m2) configured to move the robot within an environment (e.g., environment). The robot may further comprise at least one sensor (e.g., multi-directional sensor 108s1 and/or multi-directional sensor 108s2). In various aspects, the sensor may comprise a joystick sensor, a Hall-effect sensor, an IMU, a sensor for detecting motor current, or any other sensor as described herein. The robot may further comprise a processor (e.g., processor 112) communicatively coupled to the at least one sensor. A computer memory (e.g., computer memory 114) may be communicatively coupled to the processor. The computer memory can store computing instructions that, when executed by the processor, cause the processor to implement navigation algorithm 1200. It is to be understood that navigation algorithm 1200 is an example non-limiting algorithm that may form a portion of, or otherwise be stored or implemented as part of, the computing instructions stored on memory 114 and executable by processor 112. Additional or alternative algorithms may also be stored and executed by memory 114 and processor 112, respectively, including those as described herein.

With further reference to FIG. 12, block 1202 of navigation algorithm 1200 comprises actuating at least one motor to drive the robot in a direction having a forward motion relative to the front portion of the robot. For example, as shown for FIG. 13A, navigation algorithm 1200 comprises actuating at least one motor (e.g., motor 254m1 and/or motor 254m2) to drive the robot (e.g., robot 100) in a first direction 1302 having a forward motion relative to the front portion of the robot.

With reference to FIG. 12, block 1204 of navigation algorithm 1200 comprises, upon detection of a trigger action, actuating the at least one motor to drive the robot within the environment in a chevron pattern relative to a departure area from the direction. For example, as shown for FIG. 13A, navigation algorithm 1200 further comprises, upon detection of a trigger action, actuating the at least one motor to drive the robot within the environment in a chevron pattern (e.g., a V-shaped pattern) relative to a departure area 1304. In some aspects, a departure area (e.g., departure area 1304) may comprise a tip of, or joining section of, a portion of the chevron navigation pattern or area, from which the robot departs from a wall after traveling in the first direction, e.g., as shown, by way of non-limiting example, by FIG. 13A.

In some aspects, the trigger action may comprise a predefined distance traveled in the first direction. For example, robot 100 may travel along a non-altering heading (e.g. a straight path such as first direction 1302, e.g., along a straight wall) for a pre-determined distance, such as a few millimeters or more. When the predefined distance is reached, then the action may be triggered. Additionally, or alternatively, the trigger action may comprise an elapsed amount of time traveled in the first direction. In such aspects, robot 100 may travel along a non-altering heading (e.g. a straight path such as first direction 1302, e.g., along a straight wall) for a pre-determined amount of time, such as a few seconds or more. Additionally, or alternatively, the trigger action may comprise a specific maneuver implemented by the robot. For example, after the robot 100 initiates a maneuver (e.g., after turning from one wall to the next), the action may be triggered.

Additionally, or alternatively, a trigger action may be delayed or not be implemented until travel in the first direction 1302 (e.g., travel along a straight edge such as wall) is confirmed. Such delayed or non-implemented action is referred to herein as a non-triggering action. A non-triggering action can be a delay or period for the processor (e.g., processor 112) to wait to implement or detect the triggering action. This can be caused by the robot moving along a curved surface (e.g., such as around a toilet) or otherwise a surface not having a straight edge, such that the processor 112 waits to implement a straight navigation strategy for following an edge. Delay or otherwise the non-triggering action can be implemented by adding, by processor 112, time to until triggering an action. For example, this may comprise time to confirm direction in the first direction (e.g., first direction 1302) is detected within a certain confidence value or required prediction value (e.g., 90% or more) that the robot is traveling along an edge. As a further example, the robot can dwell (e.g., follow a curve, e.g., of a toilet) or otherwise wait to finish a curved navigation pattern before the trigger action is detected or otherwise invoked. Without such delay of the trigger action, the robot could implement a chevron pattern prematurely and reduce the likelihood of returning to the appropriate place. This would reduce the overall cleaning coverage of the robot.

Additionally, or alternatively, a trigger action can be determined based on a size or dimension of the environment to be cleaned. For example, in some aspects, the robot may be configured or otherwise set to have different pre-determined distance(s), time(s), and/or maneuver triggers depending on the size and/or the dimensions of the environment being traversed or navigated. For example, the robot may be configured to implement smaller distance(s) (e.g., one to five millimeters), less time(s) (e.g., one to 2 seconds), and/or tighter maneuvers (e.g., a turn more than 10 degrees) for a smaller room (e.g., a bathroom) or otherwise environment than a larger room (e.g., a warehouse). The robot may be configured to implement greater distance(s) (e.g., six or more millimeters), more time(s) (e.g., 2 or more seconds), and/or broader maneuvers (e.g., a turn more than 10 degrees or more) for a larger room or otherwise environment.

With reference to FIG. 12, block 1206 of navigation algorithm 1200 comprises driving the robot in a plurality of segments comprising the chevron pattern. As shown for FIG. 13A, a chevron pattern 1300 may comprise, by way of non-limiting example, a plurality of segments (e.g., segments 1306s1, 1306s2, 1306s3, and 1306s4). Generally, a chevron pattern can be implemented or triggered, by processor 112, when robot 100 drives along an edge (e.g., a wall). Robot may then deviate from the edge (e.g., from departure area 1304) to implement the chevron pattern. In some aspects, a chevron pattern may comprise a 90 degree and/or L-shape navigation pattern, where each leg of the pattern includes a forward and a backward direction or segment, in which the robot 100 executes two turns (e.g., 90-degree turns) at the respective ends of a given segment. A chevron pattern may be implemented to improve a fill pattern or navigation strategy of robot, comprising the robot's traversal of the interior area of an environment, or otherwise room. The chevron navigation strategy maximizes the amount an amount of uncovered (e.g., not cleaned and/or otherwise not covered) space within an environment, as shown, for example, by FIG. 14, or elsewhere herein.

A chevron pattern may comprise multiple legs and/or segments. For example, as shown for FIG. 13A, driving the robot (e.g., robot 100) in chevron pattern 1300 comprises driving the robot in a first angled segment 1306s1 away from and relative to departure area 1304. Still further, driving the robot (e.g., robot 100) in the chevron pattern 1300 comprises driving the robot in a second angled segment 1306s2 back toward and relative to the departure area 1304.

Still further, driving the robot (e.g., robot 100) in the chevron pattern 1300 comprises driving the robot in a third angled segment 1306s3 away from and relative to the departure area 1304, and driving the robot in a fourth angled segment 1306s4 back toward and relative to the departure area 1304.

In various aspects, chevron pattern 1300 may be defined by the angles between one or more segments (e.g., segments 1306s1, 1306s2, 1306s3, and/or 1306s4). For example, in various aspects, at least one of first angled segment 1306s1 or the second angled segment 1306s2 form an angle (e.g., V-shaped and/or L-shaped angle(s)) with respect to at least one of third angled segment 1306s3 or fourth angled segment 1306s4. For example, such angles are shown, by way of non-limiting example, by angle 1308va1 or 1308va2. As shown, each of first angled segment 1306s1 and second angled segment 13062 form respective V-shaped angles (e.g., 1308va1 and 1308va2) with respect to third angled segment 1306s3 and fourth angled segment 1306s4. In some implementations, such angles (e.g., a V-shaped angle) may comprise angles between 45 degrees and 120 degrees. In some aspects, a given V-shaped angle may comprise an angle of 90 degrees, e.g., an L-shaped angle. As noted herein, the intersection between the angled segments may comprise a radius. For example, the intersection may comprise something similar to a U-shape with the angled segment increasing their distance from one another with increasing distance from the radius.

In various aspects each segment may overlap or not overlap depending on how the robot traverses the path of a given segment. For example, as shown for FIG. 13A, at least in some areas (e.g., area 1307a1), first angled segment 1306s1 does not overlap with the second angled segment 1306s2. As a further example, in area 1307a2 third angled segment 1306s3 does not overlap with fourth angled segment 1306s4. In some aspects, robot 100 may be configured to not overlap, or to minimize overlapping, in order to increase cleaning speed and/or conserve cleaning solution of cleaning element 402. It is worth noting that the robot may be configured to provide a consistent overlap, no overlap, or gap, throughout the first angled segment 1306s1 with the second angled segment 1306s2. In such configurations the first angled segment and the second angled segment may be generally parallel to one another. The same may be true for the third and fourth angled segments and any additional segments which may be performed by the robot.

In some aspects, however, robot 100 may be configured to overlap, e.g., by a percentage value or percentage range, to apply more of cleaning solution of cleaning element 402 to a floor area, and/or ensure a deeper clean. Such setting(s) can be programmed, via the computing instructions store on memory 114, and/or may be configurable by a user of the robot. For example, the robot (e.g., robot 100) can be configured or set such that a first angled segment (e.g., first angled segment 1306s1) overlaps (e.g., within area 1307a3) a second angled segment (e.g., second angled segment 1306s2) by a first overlap value between 0% to 30%, and preferably by 10%. As a further example, the robot (e.g., robot 100) can be configured such that a third angled segment (e.g., third angled segment 1306s3) overlaps (e.g., within area 1307a4) a fourth angled segment (e.g., fourth angled segment 1306s4) by a second overlap value between 0% to 30%, and preferably by 10%.

In various aspects, processor 112 of robot 100 may implement one or more turning algorithms or otherwise strategies for transitioning or turning from one segment to another. For example, turning may occur at the end of a given segment (e.g., for first angled segment 1306s1) and/or at or near departure area 1304 (e.g., for second angled segment 1306s2) to transition or turn the body of the robot from one segment to another. Robot 100 may be triggered or otherwise activated to turn based on an obstacle (e.g., furniture, chair, toilet, etc.) hit within the environment, upon detection when a maximum threshold distance value is reached, when a time of travel has been reached, and/or when other parameters or conditions occur.

For example, with reference to FIG. 13A, processor 112 may be configured to actuate a motor to transition robot 100 from driving along first angled segment 1306s1 to second angled segment 1306s2, or to transition the robot from driving along third angled segment 1306s3 to fourth angled segment 1306s4, when a sensor detects an object in the environment (e.g., the robot's front edge hits an obstacle).

With further reference to FIG. 13A, and as a further example, processor 112 may be configured to actuate a motor to transition robot 100 from driving along first angled segment 1306s1 to second angled segment 1306s2, or to transition robot 100 from driving along third angled segment 1306s3 to fourth angled segment 1306s4, when the processor determines that the robot has traveled a maximum distance (e.g., more than a few millimeters) away from the departure area (e.g., departure area 1304).

With further reference to FIG. 13A, and as a further example, upon transitioning from first angled segment 1306s1 to second angled segment 1306s2, or from third angled segment 1306s3 to fourth angled segment 1306s4, processor 112 may be configured to actuate the motor to rotate robot 100 rightward relative to the forward motion if the sensor detects a force on the left side, or to rotate the robot leftward relative to the forward motion if the sensor detects a force on the right side. The force may be caused by the robot hitting or colliding with an object within the environment. That is, in some aspects, a robot may be configured to turn right or left based on which side of its bumper (e.g., bumper 104) an object was detected/hit. For example, if a sensor detects that a bumper hit occurred on a right side, then robot can turn left and vice versa, e.g., such that robot 100 will turn away from the obstacle.

With reference to FIG. 12, block 1208 of navigation algorithm 1200 comprises determining, by processor 112, whether to implement a further (e.g., second, third, etc.) chevron pattern. Such determination may be implemented, for example, based on one or more setting(s) of for robot 100, including, for example, a desired number of passes in a given environment, a number of cleaning sessions to implement for the environment in a given period of time, and/or a type of cleaning sessions involving orientation of a chevron pattern. For example, orientation of a chevron pattern may comprise a clockwise chevron cleaning pattern or navigation strategy, and/or a counterclockwise cleaning pattern or navigation strategy. The robot may be set or configured, e.g., at the factory and/or by a user, to implement two cleaning sessions, each having a different orientation (e.g., one clockwise and the other counterclockwise) in order to increase coverage/cleaning of the environment. For example, in some implementations, for a second implementation of a chevron pattern, computing instructions may be further configured, when executed by processor 112, to cause the processor to actuate the motor to drive the robot in a second direction opposite a first direction (e.g., first direction 1302) having a forward motion relative to the front portion of the robot (e.g., robot 100). Upon detection of a trigger action, processor 112 can actuate the motor to drive the robot within the environment in a second chevron pattern relative to a second departure area relative to the second direction. In such implementation, robot 100 may move in at least two passes in the environment, one clockwise and the other counterclockwise, in order to provide a robust clean by maximizing coverage by diversifying direction of cleaning.

With reference to FIG. 12, block 1210 of navigation algorithm 1200 comprises, upon determining to implement a further chevron pattern, actuating the at least one motor to drive the robot (e.g., robot 100) to an adjacent departure area relative to the previous departure area. For example, as shown for FIG. 13B, processor 112 implements a further chevron pattern 1400, which comprises actuating the at least one motor to drive the robot (e.g., robot 100) to an adjacent departure area 1310 relative to a previous departure area (e.g., departure area 1304). Thus, as shown in FIGS. 13A and 13B, robot 100 starts at the bottom right of the depicted environment, and then moves in the first direction 1302, implements a chevron pattern 1300, and upon competition, moves to adjacent departure area 1310, and then implements a further chevron pattern 1400.

For example, with reference to FIG. 13B, chevron pattern 1300 may comprise a first chevron pattern. Computing instructions may be configured, when executed by processor 112, to further cause the processor 112 to actuate the motor to drive the robot within the environment in a second chevron pattern (e.g., chevron pattern 1400) relative to the first chevron pattern. The second chevron pattern (e.g., chevron pattern 1400) may comprise an adjacent area (e.g., near a same edge or wall) that has a second departure area (e.g., adjacent departure area 1310) adjacent to the departure area (e.g., departure area 1304) of the first chevron pattern 1300. In such aspects, the robot 100 can maneuver within the adjacent area to form angled segments of the second chevron pattern 1400 that the same or substantially the same pattern of at least one of the first angled segment 1306s1, the second angled segment 1306s2, the third angled segment 1306s3, or the fourth angled segment 1306s4 of the first chevron pattern 1300. For example, as shown for FIG. 13B, angled segment 1312s1 has the same or substantially the same pattern as first angled segment 1306s1, angled segment 1312s2 has the same or substantially the same pattern as second angled segment 1306s2, angled segment 1312s3 has the same or substantially the same pattern as third angled segment 1306s3, and angled segment 1312s4 has the same or substantially the same pattern as fourth angled segment 1306s4. Still further, angles formed between the segments of the second chevron pattern (e.g., chevron pattern 1400) may comprise the same or substantially the same angles as the first chevron pattern (e.g., chevron pattern 1300). For example, V-shaped angle 1314va1 forms the same or substantially angle between angled segment 1312s2 and angled segment 1312s3 that V-shaped angle 1308va1 forms between second angled segment 1306s2 and third angled segment 1306s3. The same or substantially same patterns allow the chevron pattern navigation strategy to maintain a consistent pattern, and, as consequence, maximize coverage area and therefore cleaning of the environment.

In some aspects, the segments of a second chevron pattern (e.g., chevron pattern 1400) may also overlap with the segments of a previous or first chevron pattern (e.g., chevron pattern 1300). Such overlap may be implemented, for example, to achieve additional cleaning of a given environment. For example, as shown for FIG. 13B, an additional chevron pattern can be implemented that has overlapping areas with at least first angled segment 1306s1 of chevron pattern 1300 and angled segment 1312s of chevron pattern 1400.

As a further example, with reference to FIG. 13B, computing instructions may be further configured, when executed by processor 112, to cause processor 112 to actuate a motor to continue to drive the robot 100 in the first direction 1302 following competition of implementation of a chevron pattern (e.g., chevron pattern 1300). A second area (e.g., adjacent departure area 1310) of the environment may be cleaned by the cleaning element following competition of implementation of the chevron pattern (e.g., chevron pattern 1300), where the second area (e.g. adjacent departure area 1310) may overlap (e.g., 1316a2) at least partially with a first area (e.g., departure area 1304) of the environment cleaned by the cleaning element before implementation of the chevron pattern. In such implementation, robot 100 may cover, and thus, clean, along the edges of a given environment more so than when the robot moves in the chevron pattern.

With further reference to FIG. 12, block 1212 of navigation algorithm 1200 comprises, upon determining to implement a further chevron pattern, actuating the at least one motor to drive the robot within the environment in a further chevron pattern having an opposite departure area relative to the departure area of the preceding chevron pattern. In such examples, an opposite, but mirrored, chevron pattern is implemented within the environment such that the first chevron pattern (e.g., chevron pattern 1300) and a second chevron pattern (not shown) form a diamond pattern or otherwise diamond shaped navigation within the environment. In such implementations, a mirror image or near-mirror image of first chevron shape may be implemented, so at a most distal point on a second chevron shape from departure area 1304 of a wall, robot 100 can begin navigation on an opposite wall. In some aspects, robot 100 can continue the chevron navigation strategy on the opposite wall.

For example, in some aspects, chevron pattern 1300 may comprise a first chevron pattern. The computing instructions may be configured, when executed by the processor, to further cause the processor to actuate the motor to drive the robot within the environment in a second chevron pattern relative to the first chevron pattern. The second chevron pattern may include an opposite area (e.g., near an opposite wall) that is opposite to the departure area (e.g., departure area 1304) of the first chevron pattern. Robot 100 can then maneuver within the opposite area to form angled segments of the second chevron pattern that mirror at least one of first angled segment 1306s1, second angled segment 1306s2, third angled segment 1306s3, or the fourth angled segment 1306s4 of the first chevron pattern 1300. The first chevron pattern 1300 and the second chevron pattern may form a diamond shape or nested diamond shaped navigation pattern within the environment.

With reference to FIG. 12, block 1214 of navigation algorithm 1200 comprises implementing an edge navigation pattern, for example, as depicted and described for FIGS. 8, 11, and/or 14, or elsewhere herein. For example, at block 1214, robot 100 may exit a chevron navigation state and enter an edge and/or fill state, which can be updated in memory 114. Implementation of the edge navigation pattern may comprise transitioning, by processor 112, from the chevron navigation, for transitioning from chevron pattern navigation of an interior area of an environment, to an edge following navigation strategy, for cleaning along an edge such as a wall. Still further, from a given edge state or otherwise edge following navigation strategy, robot 100 may begin a new chevron navigation state, implementing navigation algorithm 1200 again for cleaning or otherwise moving into the interior of the environment.

FIG. 14 illustrates a coverage diagram 1400 illustrating example edge navigation together with chevron pattern navigation of a robot in accordance with various aspects disclosed herein. In particular, FIG. 14 shows coverage plot or diagram showing a path that a robot (e.g., robot 100) has moved or navigated within a given environment. For example, the environment may comprise or represent a top-down view of environment 800. In various aspects, including in the example of FIG. 11, the robot (e.g., robot 100) operates in different modes related to cleaning different areas of an environment 800. For example, a robot (e.g., robot 100) may operate to clean one or more edge(s) (e.g., walls) of an environment 800 as demonstrated, for example, by forward movement 1406. FIG. 14 also shows example backward movements (e.g., backward movement 1408), which can occur before or after respective forward movements. That is, backward movements illustrate instances at which the robot (e.g., robot 100) was moving backwards relative to its cleaning element (e.g., cleaning element 402), for example, in order to implement a turning or maneuver to begin a transition from one forward movement to another. As a further example, a robot (e.g., robot 100) may operate to clean a fill zone 1410, which may comprise a non-edge area of an environment (e.g., a center or middle area of an environment 800), which may be represented, for example, by areas shown for forward movements of the robot that comprise segments of one or more chevron navigation patterns as described herein, by way of non-limiting example, for FIGS. 12, 13A, and/or 13B.

In the example of FIG. 14, the environment is defined or mapped according to a Y-Position 1402 and an X-Position 1404 defining the robot's movement within the environment 800. The positions are measured in millimeters (mm), although it is to be understood that different position values and/or measurements may be used to identify a robot's position within a given environment.

As demonstrated in the example of FIG. 14, robot 100 can move, at least in one aspect, in a chevron pattern (e.g., chevron pattern 1300), in a center area of the environment, e.g., fill zone 1410. It is to be understood, however, that additional and/or different movement patterns are contemplated herein. FIG. 14 further exemplifies a navigation or movement of a robot (e.g., robot 100) involving an edge-follow or otherwise wall-follow algorithm. This is illustrated, for example, by forward movement 1406 and backward movement 1408. As shown for FIG. 14, robot 100 follows an edge 1407 (e.g., a baseboard or otherwise a wall or an obstacle) of the environment (e.g., environment 800). Robot 100 moves in a forward direction (e.g., forward movement 1406) relative to its cleaning element (e.g., cleaning element 402) thereby cleaning near or along edge 1407 (e.g., a wall). When robot 100 approaches an obstacle (e.g., an object 1409 of the environment such a leg of a chair), then robot 100 can engage or implement backward movement 1408 in order to rotate or otherwise alter its direction to continue moving in a forward direction (x-position direction) relative to the wall. Other obstacles that may be traversed, as shown in FIG. 14, include toilet 1412 and trashcan 1414. It is to be understood that the robot may traverse additional and/or different obstacles with its edge and fill navigation strategies. In this way, robot 100 can clean a perimeter of the environment along one or more edges to ensure cleaning, disinfecting, or otherwise improving of the environment occurs not only with respect to the center of the environment (e.g., forward movement 1406), but also with respect to the edges of the environment (e.g., environment 800).

In some aspects, edges may receive additional overlaps or passes by robot 100, thus providing additional cleaning and/or coverage compared to a center of a room. In such aspects, the edge(s) of an environment may experience redundant and/or overlapping passes, but where a center, or otherwise fill area, of an environment may not experience redundant and/or overlapping passes. In other aspects, the center, or fill area, may receive redundant and/or overlapping passes, for example, as described herein for FIGS. 12, 13A, and/or 13B.

With further reference to FIG. 14, a chevron pattern, such as chevron pattern 1300, may be implemented by processor 112 at least as part of a fill pattern designed to move the robot within an interior portion of the environment (e.g., fill zone 1410). The computing instructions are configured, when executed by the processor, to further cause the processor to, prior to or following implementation of the triggering of an action (e.g., predetermined distance and/or predetermined time triggered) to actuate the at least one motor to drive the robot within the environment in the chevron pattern (e.g., chevron pattern 1300), implement an edge navigation pattern (e.g., including forward movement 1406) comprising moving the robot proximate to one or more edges situated within the environment. In various aspects, robot 100 is configured to implement a chevron pattern (e.g., chevron pattern 1300) in a plurality of instances as the robot moves in the environment, and wherein at least 90 percent of a surface area of the environment is cleaned by the cleaning element. In some instances, the robot moving a cleaning element (e.g., cleaning element 402) is configured to hold or collect at least 90 percent of a total amount of debris acquired by the cleaning element as the robot moves in the forward direction. In some aspects, different coverage amounts and/or percentages may be identified for certain areas of the environment. As shown for FIG. 14, the coverage area illustrates that robot 100 cleaned 99% of an area associated with toilet 1412.

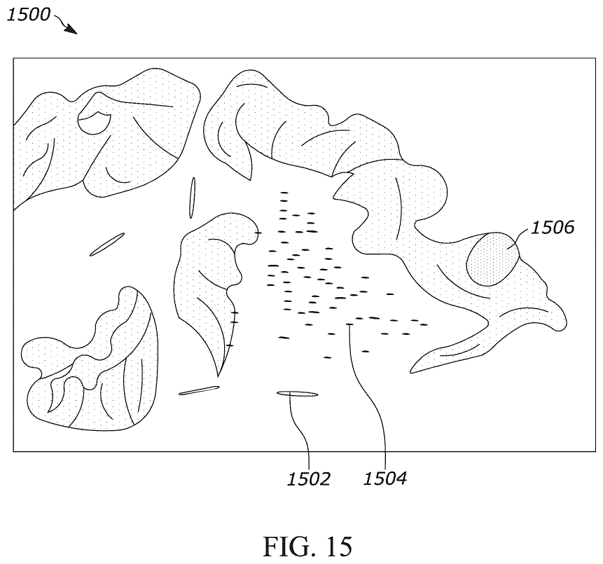

FIG. 15 illustrates example debris and sizes thereof in accordance with various aspects disclosed herein. For example, as shown in FIG. 15, by non-limiting example, debris includes rice 1502, dirt 1504, and hair 1506 as distributed on a surface (e.g., a floor) of an environment (e.g., environment 800). It should be understood, however, that additional and/or different debris, such as sand, salt, and/or other debris types or sizes are contemplated herein. In various aspects, the debris captured by a cleaning element (e.g., cleaning element 402) is of a predetermined size, such as, the size of a grain of rice or a length of hair. For example, in some aspects, the size of the debris may be between approximately 5.5e−5 mm³ and 15 mm³.

### Additional Considerations

Although the disclosure herein sets forth a detailed description of numerous different aspects, it should be understood that the legal scope of the description is defined by the words of the aspects set forth at the end of this patent and equivalents. The detailed description is to be construed as exemplary only and does not describe every possible aspect since describing every possible aspect would be impractical. Numerous alternative aspects may be implemented, using either current technology or technology developed after the filing date of this patent, which would still fall within the scope of the claims.

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain aspects are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example aspects, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example aspects, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example aspects, the processor or processors may be located in a single location, while in other aspects the processors may be distributed across a number of locations.

The performance of certain of the operations may be distributed among the one or more processors, not only residing within a single machine, but deployed across a number of machines. In some example aspects, the one or more processors or processor-implemented modules may be located in a single geographic location (e.g., within a home environment, an office environment, or a server farm). In other aspects, the one or more processors or processor-implemented modules may be distributed across a number of geographic locations.

### Aspects of the Disclosure

The following aspects are provided as examples in accordance with the disclosure herein and are not intended to limit the scope of the disclosure.
A. A robot configured for cleaning, the robot comprising:
a body comprising a chassis and an outer perimeter, and the body further comprising a front portion, an opposing back portion, and a body length disposed between the front portion and the opposing back portion,
wherein the body further comprises a cleaning element positioned relative to the front portion,
wherein the front portion comprises a right side, a left side opposing the right side, and a front portion width disposed between the right side and the left side;
at least one motor configured to move the robot within an environment;
at least one sensor;
a processor communicatively coupled to the at least one sensor;
a computer memory communicatively coupled to the processor; and
computing instructions stored on the computer memory and configured, when executed by the processor, to cause the processor to:
actuate the at least one motor to drive the robot in a first direction having a forward motion relative to the front portion of the robot,
upon detection of a trigger action, actuate the at least one motor to drive the robot within the environment in a chevron pattern relative to a departure area from the first direction,
wherein the chevron pattern comprises a plurality of segments, and
wherein driving the robot in the chevron pattern comprises:
driving the robot in a first angled segment away from and relative to the departure area,
driving the robot in a second angled segment back toward and relative to the departure area,
driving the robot in a third angled segment away from and relative to the departure area,
driving the robot in a fourth angled segment back toward and relative to the departure area,
wherein at least one of the first angled segment or the second angled segment are disposed at an angle with respect to at least one of the third angled segment or the fourth angled segment.
B. The robot of paragraph A, wherein each of the first angled segment and the second angled segment form respective V-shaped angles with respect to the third angled segment and the fourth angled segment.
C. The robot of any of paragraph A or B, wherein the angle between the first angled segment and the third angled segment or fourth angled segment cis from between about 45 degrees and about 120 degrees.
D. The robot of any of paragraphs A through C, wherein the angle is about 90 degrees.
E. The robot of any of paragraphs A through D, wherein the trigger action comprises one or more of: (a) a predefined distance traveled in the first direction; (b) an elapsed amount of time traveled in the first direction; or (c) after initiating a maneuver; or (d) due to contact with an obstacle in the environment as determined by a sensor response.
F. The robot of any of paragraphs A through E, wherein the trigger action is delayed or is not implemented until travel in the first direction is confirmed.
G. The robot of any of paragraphs A through F, wherein the trigger action is determined based on a size or dimension of the environment to be cleaned.
H. The robot of any of paragraphs A through G, wherein the processor is configured to actuate the at least one motor to transition the robot from driving along the first angled segment to the second angled segment, or to transition the robot from driving along the third angled segment to the fourth angled segment, when the sensor detects an object in the environment.
I. The robot of any of paragraphs A through H, wherein the processor is configured to actuate the at least one motor to transition the robot from driving along the first angled segment to the second angled segment, or to transition the robot from driving along the third angled segment to the fourth angled segment, when the processor determines that the robot has traveled a maximum distance away from the departure area.
J. The robot of any of paragraphs A through I, wherein upon transitioning from the first angled segment to the second angled segment or from the third angled segment to the fourth angled segment, the processor is configured to actuate the at least one motor to rotate the robot rightward relative to the forward motion if the sensor detects a force on the left side, or to rotate the robot leftward relative to the forward motion if the sensor detects a force on the right side.
K. The robot of any of paragraphs A through J, wherein the robot is configured to implement the chevron pattern in a plurality of instances as the robot moves in the environment, and wherein at least 90 percent of a surface area of the environment is cleaned by the cleaning element.
L. The robot of any of paragraphs A through K, wherein the computing instructions are further configured, when executed by the processor, to cause the processor to:
actuate the at least one motor to drive the robot in a second direction opposite first direction and having a forward motion relative to the front portion of the robot,
upon detection of the trigger action, actuate the at least one motor to drive the robot within the environment in a second chevron pattern relative to a second departure area relative to the second direction.
M. The robot of any of paragraphs A through L, wherein the robot moving the cleaning element is configured to hold or collect at least 90 percent of a total amount of debris acquired by the cleaning element as the robot moves in the forward direction.
N. The robot of any of paragraphs A through M, wherein the computing instructions are further configured, when executed by the processor, to cause the processor to:
actuate the at least one motor to continue to drive the robot in the first direction following competition of implementation of the chevron pattern,
wherein a second area of the environment cleaned by the cleaning element following competition of implementation of the chevron pattern overlaps at least partially with a first area of the environment cleaned by the cleaning element before implementation of the chevron pattern.
O. The robot of any of paragraphs A through N, wherein at least one of: (a) the first angled segment does not overlap with the second angled segment; and/or (b) the third angled segment does not overlap with the fourth angled segment.
P. The robot of any of paragraphs A through O, wherein at least one of: (a) the first angled segment overlaps the second angled segment by a first overlap value between 0% to 30%, and preferably by 10%; and/or (b) the third angled segment overlaps the fourth angled segment by a second overlap value between 0% to 30%, and preferably by 10%.
Q. The robot of any of paragraphs A through P, wherein the sensor is a displacement sensor comprising at least one of: a joystick sensor, variable resistance sensor, hall effect sensor, motor current sensor, inertial measurement unit “IMU” sensor, a potentiometer, pressure switch, time of flight, capacitive the like or combination thereof.
R. The robot of any of paragraphs A through Q, wherein the chevron pattern comprises a first chevron pattern, and wherein the computing instructions are configured, when executed by the processor, to further cause the processor to:
actuate the at least one motor to drive the robot within the environment in a second chevron pattern relative to the first chevron pattern,
wherein the second chevron pattern includes an adjacent area that has an second departure area adjacent to the departure area of the first chevron pattern, and
wherein the robot maneuvers within the adjacent area to form angled segments of the second chevron pattern that the same or substantially the same pattern of at least one of the first angled segment, the second angled segment, the third angled segment, or the fourth angled segment of the first chevron pattern.
S. The robot of any of paragraphs A through R, wherein the chevron pattern comprises a first chevron pattern, and wherein the computing instructions are configured, when executed by the processor, to further cause the processor to:
actuate the at least one motor to drive the robot within the environment in a second chevron pattern relative to the first chevron pattern,
wherein the second chevron pattern includes an opposite area that is opposite to the departure area of the first chevron pattern, and
wherein the robot maneuvers within the opposite area to form angled segments of the second chevron pattern that mirror at least one of the first angled segment, the second angled segment, the third angled segment, or the fourth angled segment of the first chevron pattern.
T. The robot of any of paragraphs A through S, wherein the chevron pattern is implemented by the processor at least as part of a fill pattern designed to move the robot within an interior portion of the environment, and
wherein the computing instructions are configured, when executed by the processor, to further cause the processor to:
prior to or following implementation of triggering the action to actuate the at least one motor to drive the robot within the environment in the chevron pattern,
implement an edge navigation pattern comprising moving the robot proximate to one or more edges situated within the environment.

This detailed description is to be construed as exemplary only and does not describe every possible aspect, as describing every possible aspect would be impractical, if not impossible. A person of ordinary skill in the art may implement numerous alternate aspects, using either current technology or technology developed after the filing date of this application.

Those of ordinary skill in the art will recognize that a wide variety of modifications, alterations, and combinations can be made with respect to the above described aspects without departing from the scope of the invention, and that such modifications, alterations, and combinations are to be viewed as being within the ambit of the inventive concept.

The patent aspects at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular aspects of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A robot configured for cleaning, the robot comprising:
a body comprising a chassis and an outer perimeter, and the body further comprising a front portion, an opposing back portion, and a body length disposed between the front portion and the opposing back portion,
wherein the body further comprises a cleaning element positioned relative to the front portion,
wherein the front portion comprises a right side, a left side opposing the right side, and a front portion width disposed between the right side and the left side;
at least one motor configured to move the robot within an environment;
at least one sensor;
a processor communicatively coupled to the at least one sensor;
a computer memory communicatively coupled to the processor; and
computing instructions stored on the computer memory and configured, when executed by the processor, to cause the processor to:
actuate the at least one motor to drive the robot in a first direction having a forward motion relative to the front portion of the robot,
upon detection of a trigger action, actuate the at least one motor to drive the robot within the environment in a chevron pattern relative to a departure area, from the first direction,
wherein the chevron pattern comprises a plurality of segments, and
wherein driving the robot in the chevron pattern comprises:
driving the robot in a first angled segment away from and relative to the departure area,
driving the robot in a second angled segment back toward and relative to the departure area,
driving the robot in a third angled segment away from and relative to the departure area,
driving the robot in a fourth angled segment back toward and relative to the departure area,
wherein at least one of the first angled segment or the second angled segment are disposed at an angle with respect to at least one of the third angled segment or the fourth angled segment.

2. The robot according to claim 1, wherein each of the first angled segment and the second angled segment form respective V-shaped angles, with respect to the third angled segment and the fourth angled segment.

3. The robot according to claim 1, wherein the angle between the first angled segment and the third angled segment or fourth angled segment is from between about 45 degrees and about 120 degrees.

4. The robot according to claim 1, wherein the angle is about 90 degrees.

5. The robot according to claim 1, wherein the trigger action comprises one or more of: (a) a predefined distance traveled in the first direction; (b) an elapsed amount of time traveled in the first direction; or (c) after initiating a maneuver; or (d) due to contact with an obstacle in the environment as determined by a sensor response.

6. The robot according to claim 1, wherein the trigger action is delayed or is not implemented until travel in the first direction is confirmed.

7. The robot according to claim 1, wherein the trigger action is determined based on a size or dimension of the environment to be cleaned.

8. The robot according to claim 1, wherein the processor is configured to actuate the at least one motor to transition the robot from driving along the first angled segment to the second angled segment, or to transition the robot from driving along the third angled segment to the fourth angled segment, when the sensor detects an object in the environment.

9. The robot according to claim 1, wherein the processor is configured to actuate the at least one motor to transition the robot from driving along the first angled segment to the second angled segment, or to transition the robot from driving along the third angled segment to the fourth angled segment, when the processor determines that the robot has traveled a maximum distance away from the departure area.

10. The robot according to claim 1, wherein upon transitioning from the first angled segment to the second angled segment or from the third angled segment to the fourth angled segment, the processor is configured to actuate the at least one motor to rotate the robot rightward relative to the forward motion if the sensor detects a force on the left side, or to rotate the robot leftward relative to the forward motion if the sensor detects a force on the right side.

11. The robot according to claim 1, wherein the robot is configured to implement the chevron pattern in a plurality of instances as the robot moves in the environment, and wherein at least 90 percent of a surface area of the environment is cleaned by the cleaning element.

12. The robot according to claim 1, wherein the computing instructions are further configured, when executed by the processor, to cause the processor to:
actuate the at least one motor to drive the robot in a second direction opposite first direction and having a forward motion relative to the front portion of the robot,
upon detection of the trigger action, actuate the at least one motor to drive the robot within the environment in a second chevron pattern relative to a second departure area relative to the second direction.

13. The robot according to claim 1, wherein the robot moving the cleaning element is configured to hold or collect at least 90 percent of a total amount of debris acquired by the cleaning element as the robot moves in the forward direction.

14. The robot according to claim 1, wherein the computing instructions are further configured, when executed by the processor, to cause the processor to:
actuate the at least one motor to continue to drive the robot in the first direction following competition of implementation of the chevron pattern,
wherein a second area of the environment cleaned by the cleaning element following competition of implementation of the chevron pattern overlaps at least partially with a first area of the environment cleaned by the cleaning element before implementation of the chevron pattern.

15. The robot according to claim 1, wherein at least one of: (a) the first angled segment does not overlap with the second angled segment; and/or (b) the third angled segment does not overlap with the fourth angled segment.

16. The robot according to claim 1, wherein at least one of: (a) the first angled segment overlaps the second angled segment by a first overlap value between 0% to 30.

17. The robot according to claim 1, wherein the sensor is a displacement sensor comprising at least one of: a joystick sensor, variable resistance sensor, hall effect sensor, motor current sensor, inertial measurement unit “IMU” sensor, a potentiometer, pressure switch, time of flight, capacitive sensor, or combination thereof.

18. The robot according to claim 1, wherein the chevron pattern comprises a first chevron pattern, and wherein the computing instructions are configured, when executed by the processor, to further cause the processor to:
actuate the at least one motor to drive the robot within the environment in a second chevron pattern relative to the first chevron pattern,
wherein the second chevron pattern includes an adjacent area that has an second departure area adjacent to the departure area of the first chevron pattern, and
wherein the robot maneuvers within the adjacent area to form angled segments of the second chevron pattern that the same or substantially the same pattern of at least one of the first angled segment, the second angled segment, the third angled segment, or the fourth angled segment of the first chevron pattern.

19. The robot according to claim 1, wherein the chevron pattern comprises a first chevron pattern, and wherein the computing instructions are configured, when executed by the processor, to further cause the processor to:
actuate the at least one motor to drive the robot within the environment in a second chevron pattern relative to the first chevron pattern,
wherein the second chevron pattern includes an opposite area that is opposite to the departure area of the first chevron pattern, and
wherein the robot maneuvers within the opposite area to form angled segments of the second chevron pattern that mirror at least one of the first angled segment, the second angled segment, the third angled segment, or the fourth angled segment of the first chevron pattern.

20. The robot according to claim 1, wherein the chevron pattern is implemented by the processor at least as part of a fill pattern designed to move the robot within an interior portion of the environment, and
wherein the computing instructions are configured, when executed by the processor, to further cause the processor to:
prior to or following implementation of triggering the action to actuate the at least one motor to drive the robot within the environment in the chevron pattern,
implement an edge navigation pattern comprising moving the robot proximate to one or more edges situated within the environment.
